(19) United States
(12) Patent Application Publication
(10) Pub. No.: US 2023/0171625 A1
(43) Pub. Date: Jun. 1, 2023

(54) INTERFERENCE MEASUREMENT OF SENSING SIGNALS

(71) Applicant: QUALCOMM INCORPORATED, San Diego, CA (US)

(72) Inventors: Ruifeng MA, Beijing (CN); Yuwei REN, Beijing (CN); Huilin XU, Temecula, CA (US)

(21) Appl. No.: 17/997,689

(22) PCT Filed: Jul. 1, 2020
(86) PCT No.: PCT/CN2020/099762

§ 371 Date: Nov. 1, 2022

(51) Int. Cl. H04W 24/08; H04W 72/541; H04W 72/56; H04W 24/10

(52) U.S. Cl. CPC H04W 24/08; H04W 72/541; H04W 72/56; H04W 24/10

(57) ABSTRACT

Methods, systems, and devices for wireless communications are described. A base station may identify a set of sensing resources to be used by a first user equipment (UE) for transmission of sensing signals. The base station may receive one or more uplink signals from a second UE, and determine interference at the second UE associated with the sensing signals transmitted by the first UE based at least in part on the set of sensing resources, the one or more uplink signals received from the second UE, or both. The base station may transmit, based at least in part on determination of the interference at the second UE, a configuration message to at least one of the first UE or the second UE. The configuration message may include an indication of a parameter adjustment pertaining to at least one of transmission of the sensing signals by the first UE or downlink reception by the second UE.

### CROSS REFERENCE

The present application is a 371 national stage filing of International PCT Application No. PCT/CN2020/099762 by M A et al. entitled “INTERFERENCE MEASUREMENT OF SENSING SIGNALS,” filed Jul. 1, 2020, which is assigned to the assignee hereof, and which is expressly incorporated by reference in its entirety herein.

### FIELD OF TECHNOLOGY

The following relates generally to wireless communications and more specifically to interference measurement of sensing signals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a wireless device (e.g., a user equipment (UE)) may be configured to transmit sensing signals, such as radar sensing signals or millimeter wave (mmW) sensing signals, in order to carry out sensing applications. However, the presence of sensing signals within the communication band may result in interference at other wireless devices. Left unmanaged, interference resulting from sensing signals may result in excessive noise and negatively impact the efficiency and reliability of wireless communications.

### SUMMARY

The described techniques relate to improved methods, systems, devices, and apparatuses that support interference measurement of sensing signals. Generally, the described techniques provide for management of sensing signal interference. In some aspects, a base station may determine interference experienced by a “victim” user equipment (UE) which is attributable to sensing signals transmitted by a “sensing” UE in order to manage sensing signal interference. In some aspects, the base station may configure the victim UE with a set of interference measurement resources for measuring interference attributable to sensing signals transmitted by the sensing UE. The victim UE may perform measurements of the sensing signals, and transmit a measurement report to the base station. The base station may then selectively adjust parameters associated with the sensing signals transmitted by the sensing UE, resources used for signal reception by the victim UE, or both, in order to mitigate the interference. In additional or alternative aspects, the base station may determine the interference experienced by the victim UE by determining a pathloss of a signal transmitted between the sensing UE and the victim UE. In particular, the base station may determine relative positions of the sensing UE and the victim UE relative to each other, and may estimate the pathloss between the UEs based on the relative positions of the UEs.

A method of wireless communication at a base station is described. The method may include identifying a set of sensing resources to be used by a first UE for transmission of sensing signals, receiving one or more uplink signals from a second UE, determining interference at the second UE associated with the sensing signals transmitted by the first UE based on the set of sensing resources, the one or more uplink signals received from the second UE, or both, and transmitting, based on determination of the interference at the second UE, a configuration message to at least one of the first UE or the second UE, the configuration message including an indication of a parameter adjustment pertaining to at least one of transmission of the sensing signals by the first UE or downlink reception by the second UE.

An apparatus for wireless communication at a base station is described. The apparatus may include a processor, memory coupled with the processor, and instructions stored in the memory. The instructions may be executable by the processor to cause the apparatus to identify a set of sensing resources to be used by a first UE for transmission of sensing signals, receive one or more uplink signals from a second UE, determine interference at the second UE associated with the sensing signals transmitted by the first UE based on the set of sensing resources, the one or more uplink signals received from the second UE, or both, and transmit, based on determination of the interference at the second UE, a configuration message to at least one of the first UE or the second UE, the configuration message including an indication of a parameter adjustment pertaining to at least one of transmission of the sensing signals by the first UE or downlink reception by the second UE.

Another apparatus for wireless communication at a base station is described. The apparatus may include means for identifying a set of sensing resources to be used by a first UE for transmission of sensing signals, receiving one or more uplink signals from a second UE, determining interference at the second UE associated with the sensing signals transmitted by the first UE based on the set of sensing resources, the one or more uplink signals received from the second UE, or both, and transmitting, based on determination of the interference at the second UE, a configuration message to at least one of the first UE or the second UE, the configuration message including an indication of a parameter adjustment pertaining to at least one of transmission of the sensing signals by the first UE or downlink reception by the second UE.

A non-transitory computer-readable medium storing code for wireless communication at a base station is described. The code may include instructions executable by a processor to identify a set of sensing resources to be used by a first UE for transmission of sensing signals, receive one or more uplink signals from a second UE, determine interference at the second UE associated with the sensing signals transmitted by the first UE based on the set of sensing resources, the one or more uplink signals received from the second UE, or both, and transmit, based on determination of the interference at the second UE, a configuration message to at least one of the first UE or the second UE, the configuration message including an indication of a parameter adjustment pertaining to at least one of transmission of the sensing signals by the first UE or downlink reception by the second UE.

Some examples of the method, apparatuses, and non-transitory computer-readable medium described herein may further include operations, features, means, or instructions for transmitting, to the second UE, a second configuration message indicating a set of interference measurement resources associated with the sensing signals transmitted by the first UE, and receiving, from the second UE via the one or more uplink signals, a measurement report based on the set of interference measurement resources, where determining the interference at the second UE may be based on receiving the measurement report.

Some examples of the method, apparatuses, and non-transitory computer-readable medium described herein may further include operations, features, means, or instructions for transmitting, to the second UE via the second configuration message, information indicative that the set of interference measurement resources include an entire reception bandwidth associated with the second UE.

Some examples of the method, apparatuses, and non-transitory computer-readable medium described herein may further include operations, features, means, or instructions for transmitting, to the second UE via the second configuration message, an indication that the set of interference measurement resources include a set of cross-link interference measurement resources for measuring interference associated with the sensing signals transmitted by the first UE.

In some examples of the method, apparatuses, and non-transitory computer-readable medium described herein, the set of cross-link interference measurement resources for measuring interference associated with the sensing signals transmitted by the first UE may have a lesser priority than a set of downlink resources used by the second UE which at least partially overlap with the set of cross-link interference measurement resources.

In some examples of the method, apparatuses, and non-transitory computer-readable medium described herein, the set of interference measurement resources include a set of cross-link interference measurement resources for measuring a received signal strength indicator of the sensing signals transmitted by the first UE.

In some examples of the method, apparatuses, and non-transitory computer-readable medium described herein, the set of interference measurement resources include a set of cross-link interference measurement resources for measuring one or more parameters associated with reference signals transmitted by the first UE.

In some examples of the method, apparatuses, and non-transitory computer-readable medium described herein, transmitting the configuration message to at least one of the first UE or the second UE may include operations, features, means, or instructions for transmitting, to the first UE, a first configuration message including an indication to selectively adjust one or more parameters associated with the sensing signals transmitted by the first UE, and transmitting, to the second UE, a second configuration message including an indication to selectively adjust one or more downlink reception parameters used by the second UE.

Some examples of the method, apparatuses, and non-transitory computer-readable medium described herein may further include operations, features, means, or instructions for transmitting, to the first UE, a configuration for the set of sensing resources to be used for transmission of the sensing signals.

In some examples of the method, apparatuses, and non-transitory computer-readable medium described herein, identifying the set of sensing resources may include operations, features, means, or instructions for receiving, from the first UE, an uplink message indicating the set of sensing resources to be used for transmission of the sensing signals.

In some examples of the method, apparatuses, and non-transitory computer-readable medium described herein, determining the interference at the second UE may include operations, features, means, or instructions for determining a relative position of the second UE with respect to the first UE, and determining the interference at the second UE based on the relative position.

In some examples of the method, apparatuses, and non-transitory computer-readable medium described herein, determining the relative position of the second UE with respect to the first UE may include operations, features, means, or instructions for determining a pathloss between the first UE and the second UE.

Some examples of the method, apparatuses, and non-transitory computer-readable medium described herein may further include operations, features, means, or instructions for including the second UE and the relative position of the second UE in a storage object that also includes other UEs and respective other relative positions in relation to the first UE.

In some examples of the method, apparatuses, and non-transitory computer-readable medium described herein, the set of sensing resources include a set of time resources and a set of frequency resources.

Some examples of the method, apparatuses, and non-transitory computer-readable medium described herein may further include operations, features, means, or instructions for identifying that a first subcarrier spacing associated with the set of sensing resources may be larger than a second subcarrier spacing associated with an active bandwidth part of the second UE.

Some examples of the method, apparatuses, and non-transitory computer-readable medium described herein may further include operations, features, means, or instructions for including, in the configuration message transmitted to the first UE, a sensing signal adjustment such that less than all symbols configured for the sensing signals may be used for transmission of the sensing signals.

Some examples of the method, apparatuses, and non-transitory computer-readable medium described herein may further include operations, features, means, or instructions for including, in the configuration message transmitted to the first UE, a subcarrier spacing adjustment such that the first subcarrier spacing may be updated to equal the second subcarrier spacing.

In some examples of the method, apparatuses, and non-transitory computer-readable medium described herein, a starting position and a number of symbols in the sensing signals may be not multiples of the first subcarrier spacing divided by the second subcarrier spacing.

A method of wireless communication at a first UE is described. The method may include receiving, from a base station, a first configuration message indicating a set of interference measurement resources associated with a set of sensing resources to be used by a second UE for transmission of sensing signals, performing one or more measurements on one or more signals received from the second UE within the set of interference measurement resources, and transmitting, to the base station, a measurement report based on the one or more measurements.

An apparatus for wireless communication at a first UE is described. The apparatus may include a processor, memory coupled with the processor, and instructions stored in the memory. The instructions may be executable by the processor to cause the apparatus to receive, from a base station, a first configuration message indicating a set of interference measurement resources associated with a set of sensing resources to be used by a second UE for transmission of sensing signals, perform one or more measurements on one or more signals received from the second UE within the set of interference measurement resources, and transmit, to the base station, a measurement report based on the one or more measurements.

Another apparatus for wireless communication at a first UE is described. The apparatus may include means for receiving, from a base station, a first configuration message indicating a set of interference measurement resources associated with a set of sensing resources to be used by a second UE for transmission of sensing signals, performing one or more measurements on one or more signals received from the second UE within the set of interference measurement resources, and transmitting, to the base station, a measurement report based on the one or more measurements.

A non-transitory computer-readable medium storing code for wireless communication at a first UE is described. The code may include instructions executable by a processor to receive, from a base station, a first configuration message indicating a set of interference measurement resources associated with a set of sensing resources to be used by a second UE for transmission of sensing signals, perform one or more measurements on one or more signals received from the second UE within the set of interference measurement resources, and transmit, to the base station, a measurement report based on the one or more measurements.

Some examples of the method, apparatuses, and non-transitory computer-readable medium described herein may further include operations, features, means, or instructions for receiving, from the base station and based on transmission of the measurement report, a second configuration message indicating that the first UE may be to selectively adjust one or more downlink reception parameters used by the first UE.

Some examples of the method, apparatuses, and non-transitory computer-readable medium described herein may further include operations, features, means, or instructions for receiving, from the base station via the first configuration message, an indication that the set of interference measurement resources include a set of cross-link interference measurement resources for measuring interference associated with the sensing signals transmitted by the second UE.

In some examples of the method, apparatuses, and non-transitory computer-readable medium described herein, the set of cross-link interference measurement resources for measuring interference associated with the sensing signals transmitted by the second UE may have a lesser priority than a set of downlink resources used by the first UE which at least partially overlap with the set of cross-link interference measurement resources.

Some examples of the method, apparatuses, and non-transitory computer-readable medium described herein may further include operations, features, means, or instructions for determining that the set of cross-link interference measurement resources at least partially overlap with the set of downlink resources used by the first UE, refraining from performing measurements using the set of cross-link interference measurement resources based on determining that the cross-link interference measurement resources at least partially overlap with the set of downlink resources, and receiving one or more downlink messages using the set of downlink resources based on determining that the cross-link interference measurement resources at least partially overlap with the set of downlink resources.

Some examples of the method, apparatuses, and non-transitory computer-readable medium described herein may further include operations, features, means, or instructions for receiving, from the base station via the first configuration message, an indication that the set of interference measurement resources include a set of cross-link interference measurement resources for measuring a received signal strength indicator of the sensing signals transmitted by the second UE, and receiving the sensing signals transmitted by the second UE, where the one or more measurements may be performed on the sensing signal based on the indication that the set of interference measurement resources include a set of cross-link interference measurement resources for measuring a received signal strength indicator of the sensing signals.

Some examples of the method, apparatuses, and non-transitory computer-readable medium described herein may further include operations, features, means, or instructions for receiving, from the base station via the first configuration message, an indication that the set of interference measurement resources include a set of cross-link interference measurement resources for measuring a one or more parameters associated with reference signals transmitted by the first UE, and receiving reference signals transmitted by the second UE, where the one or more measurements may be performed on the reference signals based on the indication that the set of interference measurement resources include a set of cross-link interference measurement resources for measuring a one or more parameters associated with the reference signals.

Some examples of the method, apparatuses, and non-transitory computer-readable medium described herein may further include operations, features, means, or instructions for receiving, from the base station, information indicative that the set of interference measurement resources include an entire reception bandwidth associated with the first UE.

In some examples of the method, apparatuses, and non-transitory computer-readable medium described herein, the set of interference measurement resources include a set of time resources and a set of frequency resources.

Some examples of the method, apparatuses, and non-transitory computer-readable medium described herein may further include operations, features, means, or instructions for identifying that a first subcarrier spacing associated with the set of sensing resources may be larger than a second subcarrier spacing associated with an active bandwidth part of the second UE.

Some examples of the method, apparatuses, and non-transitory computer-readable medium described herein may further include operations, features, means, or instructions for identifying that less than all symbols configured for the sensing signals may be used for transmission of the sensing signals.

Some examples of the method, apparatuses, and non-transitory computer-readable medium described herein may further include operations, features, means, or instructions for identifying that a starting position and a number of symbols in the sensing signals may be not multiples of the first subcarrier spacing d

### BRIEF DESCRIPTION OF THE DRAWINGS

FIG. 1 illustrates an example of a wireless communications system that supports interference measurement of sensing signals in accordance with aspects of the present disclosure.

FIG. 2 illustrates an example of a wireless communications system that supports interference measurement of sensing signals in accordance with aspects of the present disclosure.

FIG. 3 illustrates an example of a process flow that supports interference measurement of sensing signals in accordance with aspects of the present disclosure.

FIGS. 4 and 5 show block diagrams of devices that support interference measurement of sensing signals in accordance with aspects of the present disclosure.

FIG. 6 shows a block diagram of a communications manager that supports interference measurement of sensing signals in accordance with aspects of the present disclosure.

FIG. 7 shows a diagram of a system including a device that supports interference measurement of sensing signals in accordance with aspects of the present disclosure.

FIGS. 8 and 9 show block diagrams of devices that support interference measurement of sensing signals in accordance with aspects of the present disclosure.

FIG. 10 shows a block diagram of a communications manager that supports interference measurement of sensing signals in accordance with aspects of the present disclosure.

FIG. 11 shows a diagram of a system including a device that supports interference measurement of sensing signals in accordance with aspects of the present disclosure.

FIGS. 12 through 16 show flowcharts illustrating methods that support interference measurement of sensing signals in accordance with aspects of the present disclosure.

### DETAILED DESCRIPTION

In some wireless communications systems, a wireless device (e.g., a user equipment (UE)) may be configured to transmit sensing signals, such as radar sensing signals or millimeter wave (mmW) sensing signals, in order to carry out sensing applications. Sensing applications may be used to identify hand gestures, three-dimensional imaging, virtual reality imaging, beam tracking, distance determinations, and the like. In some cases, a UE may be able to transmit both data transmission signals (e.g., uplink signals, sidelink signals) and sensing signals within a communication band associated with the UE. However, the presence of sensing signals within the communication band may result in interference at other wireless devices. For example, a first UE (e.g., “sensing” UE) which transmits sensing signals may cause interference with communications at a second UE (e.g., “victim” UE). Left unmanaged, interference resulting from sensing signals may result in excessive noise and negatively impact the efficiency and reliability of wireless communications.

To address interference issues associated with sensing signals transmitted by sensing UEs, techniques for management of sensing signal interference are described. Generally, the described techniques provide for management of sensing signal interference. In some aspects, a base station may determine interference experienced by a “victim” UE which is attributable to sensing signals transmitted by a “sensing” UE in order to manage sensing signal interference. In some aspects, the base station may configure the victim UE with a set of interference measurement resources for measuring interference attributable to sensing signals transmitted by the sensing UE. The set of interference measurement resources may correspond to a set of time/frequency resources of a reference signals, sensing signals, or both, transmitted by the sensing UE. The set of interference measurement resources may also be measured via wideband received signal strength indicator (RSSI). The victim UE may perform measurements of the sensing signals, and transmit a measurement report to the base station. The base station may then selectively adjust parameters associated with the sensing signals transmitted by the sensing UE, resources used for signal reception by the victim UE, or both, in order to mitigate the interference.

In additional or alternative aspects, the base station may determine the interference experienced by the victim UE by determining a pathloss of a signal transmitted between the sensing UE and the victim UE. In particular, the base station may determine relative positions of the sensing UE and the victim UE relative to each other based on uplink signals received from the sensing UE and the victim UE. In such cases, the base station may estimate the pathloss between the UEs based on the relative positions of the UEs.

Aspects of the disclosure are initially described in the context of wireless communications systems. Additional aspects of the disclosure are described in the context of an example process flow. Aspects of the disclosure are further illustrated by and described with reference to apparatus diagrams, system diagrams, and flowcharts that relate to interference measurement of sensing signals.

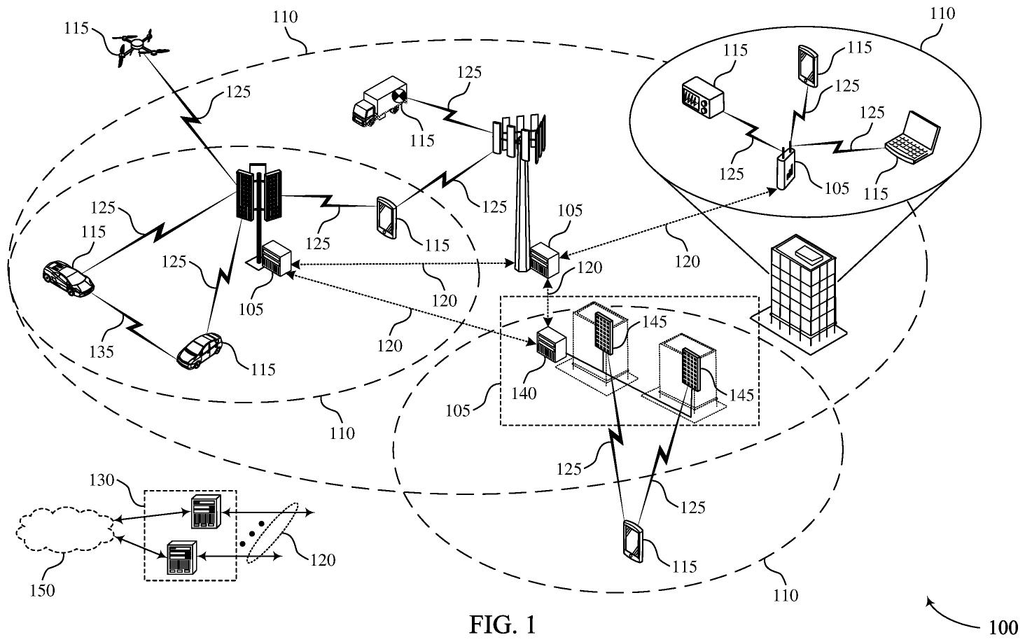

FIG. 1 illustrates an example of a wireless communications system 100 that supports interference measurement of sensing signals in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

As noted previously herein, some UEs 115 may be able to transmit both data transmission signals (e.g., uplink signals, sidelink signals) and sensing signals within a communication band associated with the UEs 115. However, the presence of sensing signals within the communication band may result in interference at other wireless devices. For example, a first UE 115 (e.g., “sensing” UE 115) which transmits sensing signals may cause interference with communications at a second UE 115 (e.g., “victim” UE 115). Left unmanaged, interference resulting from sensing signals may result in excessive noise and negatively impact the efficiency and reliability of wireless communications.

Accordingly, the UEs 115 and the base stations 105 of the wireless communications system 100 may support techniques for management of sensing signal interference. In particular, techniques described herein may enable a victim UE 115 and/or a base station 105 to estimate interference at the victim UEs 115 which is attributable to sensing signals transmitted by the sensing UE 115. Based on estimated interference experienced by the victim UE 115, the base station 105 may selectively adjust parameters associated with the sensing UE 115, the victim UE 115, or both, to address the estimated interference.

For example, a base station 105 of the wireless communications system 100 may configure a victim UE 115 with a set of interference measurement resources for measuring interference attributable to sensing signals transmitted by a sensing UE 115. The set of interference measurement resources may correspond to a set of time/frequency resources of a reference signals, sensing signals, or both, transmitted by the sensing UE 115. The set of interference measurement resources may also be measured via wideband RSSI. The victim UE 115 may perform measurements of the sensing signals, and transmit a measurement report to the base station 105. The base station 105 may then selectively adjust parameters associated with the sensing signals transmitted by the sensing UE 115, resources used for signal reception (e.g., downlink reception) by the victim UE 115, or both, in order to mitigate the interference.

In additional or alternative aspects, the base station 105 may determine the interference experienced by the victim UE 115 by determining a pathloss of a signal transmitted between the sensing UE 115 and the victim UE 115. In particular, the base station 105 may determine relative positions of the sensing UE 115 and the victim UE 115 relative to each other based on uplink signals received from the sensing UE 115 and the victim UE 115. In such cases, the base station 105 may estimate the pathloss between the UEs 115 based on the relative positions of the UEs 115.

In some aspects, the sensing UE 115 may be configured to perform one or more sensing applications. For example, a first sensing application may be associated with identifying hand gestures of a user, and a second sensing application may be associated with longer-range virtual reality imaging. Different sensing applications may be associated with different sets of sensing signal parameters, and may therefore result in varying levels of interference at potential victim UEs 115. In this regard, the base station 105 may be configured to estimate interference attributable to sensing signals associated with each sensing application.

Techniques described herein may enable victim UEs 115 and/or base stations 105 to estimate interference attributable to sensing signals transmitted by sensing UE 115. Moreover, techniques described herein may enable the base station 105 to adjust parameters associated with the sensing signals transmitted by the sensing UE 115, parameters associated with signal reception used by the victim UE 115, or both, to reduce interference attributable to the sensing signals. Accordingly, techniques described herein may facilitate the use of sensing applications while reducing interference attributable to the sensing applications, thereby improving the efficiency and reliability of wireless communications within the wireless communications system 100.

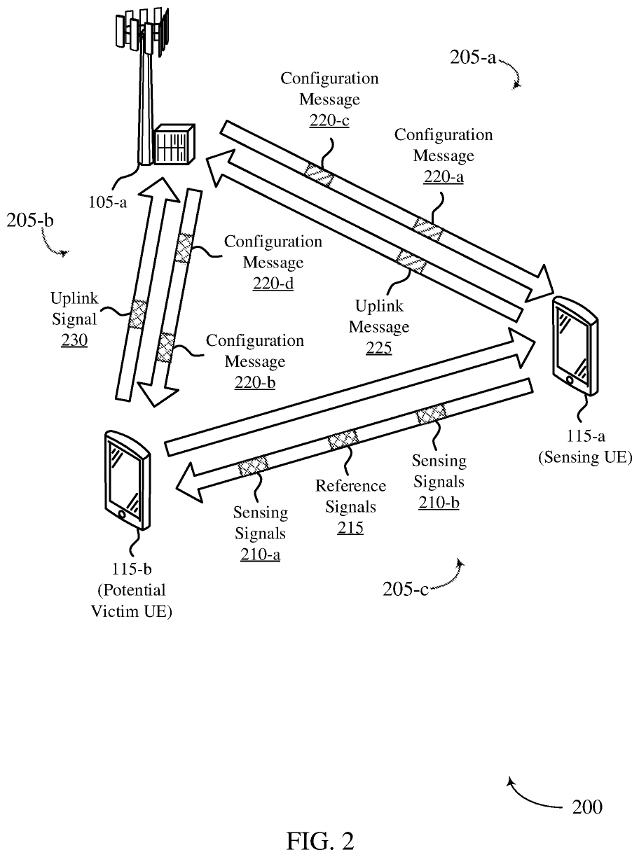

FIG. 2 illustrates an example of a wireless communications system 200 that supports interference measurement of sensing signals in accordance with aspects of the present disclosure. In some examples, wireless communications system 200 may implement aspects of wireless communications system 100. The wireless communications system 200 may include a first UE 115-a, a second UE 115-b, and a base station 105-a, which may be examples of UEs 115 and base stations 105, as described with reference to FIG. 1. In particular, the first UE 115-a may include an example of a “sensing” UE 115-a, and the second UE 115-b may include an example of a “victim” UE 115-b, as described previously herein.

The first UE 115-a and the second UE 115-b may communicate with the base station 105-a using a communication link 205-a and a communication link 205-b, respectively, which may be examples of NR or LTE links between the first UE 115-a and the second UE 115-b, respectively, and the base station 105-a. In some cases, the communication link 205-a and the communication link 205-b may include examples of access links (e.g., Uu links). The communication link 205-a and communication link 205-b may include bi-directional links that enable both uplink and downlink communication. For example, the first UE 115-a may transmit uplink signals, such as uplink control signals or uplink data signals, to the base station 105-a using the first communication link 205-a and the base station 105-a may transmit downlink signals, such as downlink control signals or downlink data signals, to the first UE 115-a using the communication link 205-a. By way of another example, the second UE 115-b may transmit uplink signals, such as uplink control signals or uplink data signals, to the base station 105-a using the first communication link 205-b and the base station 105 may transmit downlink signals, such as downlink control signals or downlink data signals, to the second UE 115-b using the communication link 205-b. The first UE 115-a and the second UE 115-b may communicate with one another via a communication link 205-c. In some cases, the communication link 205-c may include an example of a link between two UEs 115 (e.g., a sidelink communication link, or PC5 link).

In some aspects, the wireless communications system 200 may support techniques for management of sensing signal interference. In particular, techniques described herein may enable the second UE 115-b (e.g., victim UE 115-b) and/or the base station 105-a to estimate interference at the second UE 115-b which is attributable to sensing signals transmitted by the first UE 115-a. Based on estimated interference experienced by the second UE 115-b, the base station 105-a may selectively adjust parameters associated with the first UE 115-a, the second UE 115-b, or both, to address the estimated interference.

For example, the base station 105-a may identify (e.g., configure, determine) a set of interference measurement resources, a set of sensing resources, or both. In some aspects, the set of sensing resources may include a set of time and frequency resources to be used by the first UE 115-a to transmit sensing signals 210 associated with one or more sensing applications. Similarly, the set of interference measurement resources may include a set of time resources and a set of frequency resources associated with determining interference attributable to sensing signals 210 transmitted by the first UE 115-a. The set of interference measurement resources may be associated with signals (e.g., sensing signals 210, uplink signals, reference signals 215, sidelink signals) transmitted by the first UE 115-a. In this regard, the set of interference measurement signals may be used by the second UE 115-b to measure signals received from the first UE 115-a. For example, the set of interference measurement resources may be associated with the set of sensing resources to be used by the first UE 115-a for transmission of the sensing signals 210.

The base station 105-a may transmit a configuration message 220-a to the first UE 115-a, where the configuration message 220-a includes an indication (e.g., a configuration) of the set of sensing resources. In this regard, the configuration message 220-a may indicate a set of time resources and a set of sensing resources associated with the set of sensing resources which are to be used by the first UE 115-a for transmission of sensing signals 210. In some aspects, the base station 105-a may transmit the configuration message 220-a based on identifying (e.g., configuring) the set of sensing resources.

In some aspects, the base station 105-a may additionally identify that a first subcarrier spacing associated with the set of sensing resources and/or the set of interference measurement resources is larger than a second subcarrier spacing associated with an active BWP of the second UE 115-b. In such cases, the configuration message 220-a transmitted to the first UE 115-a may include a sensing signal adjustment such that less than all symbols configured for the sensing signals 210 are used for transmission of the sensing signals 210. Moreover, the configuration message 220-a transmitted to the first UE 115-a may include a subcarrier spacing adjustment such that the first subcarrier spacing is updated to equal the second subcarrier spacing. In some aspects, the base station 105-a may configure the set of sensing resources such that a starting position and a number of symbols in the sensing signals 210 are not multiples of the first subcarrier spacing divided by the second subcarrier spacing.

In some aspects, the base station 105-a may transmit a configuration message 220-b to the second UE 115-b, where the configuration message 220-b includes an indication (e.g., a configuration) of the set of interference measurement resources. The set of interference measurement resources may be associated with sensing signals 210 transmitted by the first UE 115-a. In this regard, the configuration message 220-b may indicate a set of time resources and a set of sensing resources associated with the set of sensing resources which are to be used by the first UE 115-a for transmission of sensing signals 210. In some aspects, the base station 105-a may transmit the configuration message 220-b based on identifying (e.g., configuring) the set of interference measurement resources.

In some aspects, the configuration message 220-b transmitted from the base station 105-a to the second UE 115-b may include information indicative that the set of interference measurement resources include an entire reception bandwidth associated with the second UE 115-b. In this regard, the configuration message 220-b may include an indication that the second UE 115-b is to perform measurements associated with sensing signals 210 transmitted by the first UE 115-a using an entire reception bandwidth associated with the second UE 115-b. Additionally or alternatively, the configuration message 220-b transmitted from the base station 105-a to the second UE 115-b may include an indication that the set of interference measurement resources include a set of cross-link interference (CLI) measurement resources for measuring interference associated with sensing signals 210 transmitted by the first UE 115-a.

For example, the configuration message 220-b transmitted to the second UE 115-b may include an indication that the set of interference measurement resources include a set of CLI measurement resources for measuring one or more parameters (e.g., RSSI) of the sensing signals 210 transmitted by the first UE 115-a. By way of another example, the configuration message 220-b may include an indication that the set of interference measurement resources include a set of CLI measurement resources for measuring one or more parameters associated with reference signals 215 transmitted by the first UE 115-a.

In some aspects, the set of interference measurement resources (e.g., CLI measurement resources) may have a lesser priority than a set of downlink resources used by the second UE 115-b when the set of interference measurement resources (e.g., CLI measurement resources) at least partially overlap with the set of downlink resources. For example, in cases where the set of measurement interference resources include CLI measurement resources for measuring interference associated with the sensing signals 210 transmitted by the first UE 115-a, the set of CLI measurement resources may have a lesser priority than a set of downlink resources used by the second UE 115-b which at least partially overlap with the set of CLI measurement resources. In some aspects, the indication of relative priority between the set of interference measurement resources (e.g., CLI measurement resources) may be indicated in the configuration message 220-b.

In some aspects, the first UE 115-a may identify the set of sensing resources to be used for transmission of sensing signals 210. In some aspects, the first UE 115-c may identify the set of sensing resources based on the configuration message 220-a. Additionally or alternatively, the first UE 115-a may determine the set of sensing signal resources associated with sensing signals 210 of a sensing application on its own. For example, in some cases, the first UE 115-a may be preconfigured with the set of sensing resources, or may select the set of sensing resources without configuration from the base station 105-a. In such cases, the first UE 115-a may transmit an uplink message 225 to the base station 105-a, where the uplink message 225 indicates the set of sensing resources to be used for transmission of sensing signals 210. In this example, the base station 105-a may identify the set of sensing resources to be used for transmission of sensing signals 210 based on the uplink message 225.

Similarly, the second UE 115-b may identify the set of interference measurement resources associated with sensing signals 210 transmitted by the first UE 115-a. In some aspects, the second UE 115-b may identify the set of sensing resources based on the configuration message 220-b. In some aspects, the second UE 115-b may determine that the set of interference measurement resources are associated with sensing signals 210 transmitted by the first UE 115-a, reference signals 215 transmitted by the first UE 115-a, or both. For example, the second UE 115-a may determine that the set of interference measurement resources include a set of CLI measurement resources for measuring one or more parameters (e.g., RSSI) associated with the sensing signals 210 transmitted by the first UE 115-a based on the configuration message 220-b. By way of another example, the second UE 115-b may determine that the set of interference measurement resources include a set of CLI measurement resources for measuring one or more parameters associated with reference signals 215 transmitted by the first UE 115-a based on the configuration message 220-b.

In some aspects, the second UE 115-b may determine a relative priority of the set of interference measurement resources relative to other sets of resources used by the second UE 115-b. For example, the second UE 115-b may determine that the set of interference measurement resources (e.g., CLI measurement resources) have a lesser priority than a set of downlink resources used by the second UE 115-b when the set of interference measurement resources at least partially overlap with the set of downlink resources. In this example, the second UE 115-b may determine that it is to refrain from performing measurements using the set of interference measurement resources when the set of interference measurement resources at least partially overlap with the set of downlink resources, as will be discussed in further detail herein.

In some aspects, the second UE 115-b may additionally determine that the first subcarrier spacing associated with the set of sensing resources and/or the set of interference measurement resources is larger than a subcarrier spacing associated with an active BWP of the second UE 115-b. In such cases, the second UE 115-b may determine that that less than all symbols configured for the sensing signals 210 are used for transmission of the sensing signals 210. Additionally or alternatively, the second UE 115-b may determine that a starting position and a number of symbols in the sensing signals 210 are not multiples of the first subcarrier spacing divided by the second subcarrier spacing.

The second UE 115-b may receive one or more signals (e.g., sensing signals 210, reference signals 215, uplink signals, sidelink signals) from the first UE 115-a. In some aspects, the signals received by the second UE 115-a may be associated with the set of interference measurement signals. In this regard, the one or more signals received from the first UE 115-a may be received within the set of interference measurement resources (e.g., within the set of time resources and the set of frequency resources associated with the set of interference measurement resources).

The one or more signals received from the first UE 115-c may include sensing signals 210, reference signals 215, uplink signals, sidelink signals, or any combination thereof. For example, in cases where the set of interference measurement resources include a set of CLI measurement resources for measuring interference and/or RSSI indicators associated with sensing signals 210 transmitted by the first UE 115-a, the second UE 115-b may receive sensing signals 210 from the first UE 115-a. By way of another example, in cases where the set of interference measurement resources include a set of CLI measurement resources for measuring one or more parameters associated with reference signals 215 transmitted by the first UE 115-a, the second UE 115-b may receive reference signals 215 from the first UE 115-a.

In some cases, the second UE 115-b may perform one or more measurements on the one or more signals (e.g., sensing signals 210, reference signals 215, uplink signals, sidelink signals) received from the first UE 115-a. The one or more measurements may include, but are not limited to, RSSI measurements, reference signal received power (RSRP) measurements, reference signal received quality (RSRQ) measurements, SNR measurements, signal-to-interference plus noise (SINR) measurements, or any combination thereof. In some aspects, the second UE 115-b may perform the one or more measurements based on receiving the configuration message 220-b, identifying the set of interference measurement resources, or both. In some cases, the second UE 115-b may generate a measurement report based on the one or more measurements.

For example, in cases where the set of interference measurement resources include a set of CLI measurement resources for measuring an RSSI indicator associated with sensing signals 210 transmitted by the first UE 115-a, the second UE 115-b may perform one or more measurements to determine an RSSI indicator associated with the sensing signals 210. By way of another example, in cases where the set of interference measurement resources include a set of CLI measurement resources for measuring one or more parameters associated with reference signals 215 transmitted by the first UE 115-a, the second UE 115-b may perform one or more measurements to determine one or more parameters (e.g., RSSI, RSRP, RSRQ, SNR, SINR) associated with the reference signals 215.

In some cases, the second UE 115-b may perform multiple sets of measurements associated with sets of sensing signals 210 associated with various sensing applications of the first UE 115-a. For example, the first UE 115-a may be configured to perform a first sensing application using a first set of sensing signals 210-a, and a second sensing application using a second set of sensing signals 210-b. In this example, the second UE 115-b may be configured to perform a first set of measurements associated with the first sensing application, and a second set of measurements associated with the second sensing application. In this regard, the second UE 115-b may be configured to perform measurements in accordance with multiple sets of interference measurement resources. In some cases, the second UE 115-b may generate a measurement report for each respective sensing application.

As noted previously herein, the set of interference measurement resources (e.g., CLI measurement resources) may have a lesser priority than other sets of resources (e.g., a set of downlink resources) used by the second UE 115-b. In particular, the set of interference measurement resources may have a lesser priority than a set of downlink resources used by the second UE 115-b which at least partially overlap the set of interference measurement resources. For example, the second UE 115-b may determine that the set of interference measurement resources (e.g., CLI measurement resources) at least partially overlap with a set of downlink resources used by the second UE 115-b. The set of interference measurement resources may overlap with the set of downlink resources in the time domain, the frequency domain, or both. In this example, the second UE 115-b may refrain from performing the measurements using the set of interference measurement resources (e.g., CLI measurement resources) based on determining that the set of interference measurement resources (e.g., CLI measurement resources) at least partially overlap with a set of downlink resources. Moreover, the second UE 115-b may receive one or more downlink messages from the base station 105-b using the set of downlink resources based on determining that the set of interference measurement resources (e.g., CLI measurement resources) at least partially overlap with a set of downlink resources, refraining from performing the measurements, or both.

In some aspects, the second UE 115-b may transmit one or more uplink signals 230 to the base station 105-a. In some cases, the second UE 115-b may transmit the one or more uplink signals 230 to the base station 105-a based on receiving the configuration message 220-b, identifying the interference measurement resources, receiving the signals (e.g., sensing signals 210, reference signals 215, uplink signals, sidelink signals) from the first UE 115-a, performing the measurements on the received signals, or any combination thereof. For example, in some cases, the one or more uplink signals 230 transmitted by the second UE 115-b 340 may include a measurement report based on performing the one or more measurements. In this regard, the second UE 115-b may report, to the base station 105-a, various parameters associated with sensing signals 210 and/or reference signals 215 received from the first UE 115-a.

In some aspects, the base station 105-a may determine interference at the second UE 115-b which is associated with sensing signals 210 transmitted by the first UE 115-a. In some aspects, the base station 105-a may determine the interference experienced by the second UE 115-a based on the set of sensing resources, the set of interference measurement resources, or both. Additionally, the base station 105-a may determine the interference experienced by the second UE 115-b based on receiving the uplink message 225, receiving the uplink signals 230 (e.g., measurement report), or both.

In some cases, the base station 105-a may determine interference at the second UE 115-b which is associated with sets of sensing signals 210 associated with various sensing applications of the first UE 115-a. For example, the first UE 115-a may be configured to perform a first sensing application using a first set of sensing signals 210-a, and a second sensing application using a second set of sensing signals 210-b. In this example, the base station 105-a may determine a first interference at the second UE 115-b which is attributable to the first set of sensing signals 210-a of the first sensing application, and a second interference at the second UE 115-b which is attributable to the second set of sensing signals 210-b of the second sensing application.

Additionally or alternatively, the base station 105-a may determine interference experienced by the second UE 115-b based on relative positions of the first UE 115-a and the second UE 115-b with respect to one another. In particular, the base station 105-a may estimate pathloss between the first UE 115-a and the second UE 115-b based on the relative positions of the first UE 115-a and the second UE 115-b with respect to one another, and may determine the interference experienced by the second UE 115-b based on the estimated pathloss.

For example, in some cases, the base station 105-a may determine a relative position of the second UE 115-b with respect to (e.g., relative to) the first UE 115-a. For instance, in some cases, the uplink signals 230 received from the second UE 115-b may include an indication of the position of the second UE 115-b. Similarly, uplink signals received from the first UE 115-a (e.g., uplink message 225, other uplink signals) may include an indication of the position of the first UE 115-a. In this example, the base station 105-a may determine the relative position of the second UE 115-b with respect to the first UE 115-a based on the indications of positions of the first UE 115-a and the second UE 115-b. Additionally, the base station 105-a may determine a pathloss between the first UE 115-a and the second UE 115-b based on the relative position of the second UE 115-b with respect to the first UE 115-a. In this regard, the base station 105-a may determine the interference experienced at the second UE 115-b which is attributable to sensing signals 210 from the first UE 115-a based on the relative position of the second UE 115-b with respect to the first UE 115-a and the estimated pathloss between the first UE 115-a and the second UE 115-b.

In cases where the base station 105-a determines a relative position of the second UE 115-a with respect to the first UE 115-a, the base station 105-a may additionally include the relative position of the second UE 115-a in storage objects associated with various sensing applications supported by the first UE 115-a. For example, the base station 105-a may include the relative position of the second UE 115-b in a first storage object associated with a first sensing application, and in a second storage object associated with a second sensing application. The storage objects may include any storage object known in the art including, but not limited to, a table, an index, a map, and the like. In some aspects, the first storage object and the second storage object may each additionally include other UEs 115 and respective other relative positions of the other UEs 115 with respect to the first UE 115-a. For example, the first storage object associated with the first sensing application may include a third UE 115 (not shown) and a relative position of the third UE 115 with respect to the first UE 115-a.

In some aspects, the base station 105-a may be configured to estimate interference and/or ranges of potential interference associated with each respective sensing application based on the storage objects associated with each respective sensing application. For example, the base station 105-a may determine, based on a first storage object associated with the first sensing application, that a UE 115 (e.g., the second UE 115-b) included within the first storage object is within a range of the first set of sensing signals 210-a associated with the first sensing application. By way of another example, the base station 105-a may determine, based on a second storage object associated with the second sensing application, that a UE 115 (e.g., the second UE 115-b) included within the second storage object is within a range of the second set of sensing signals 210-b associated with the second sensing application.

In some aspects, the base station 105-a may transmit a configuration message 220-c to the first UE 115-c, a configuration message 220-d to the second UE 115-d, or both, in order to manage (e.g., reduce, eliminate) the interference experienced by the second UE 115-b. In this regard, the base station 105-a may transmit a configuration message 220 (e.g., configuration message 220-c, configuration message 220-d) including an indication of a parameter adjustment pertaining to at least one of the sensing signals 210 transmitted by the first UE 115-a, downlink reception performed by the second UE 115-b, or both. In particular, the base station 105-a may selectively adjust parameters associated with the respective sensing applications (e.g., first sensing application, second sensing application) based on a determining a UE 115 included in a respective storage objects is within range of the sensing signals 210 associated with the respective sensing application.

For example, the base station 105-a may transmit a configuration message 220-c to the first UE 115-a. In some aspects, the configuration message 220-c may include an indication for the first UE 115-a to selectively adjust one or more parameters associated with the sensing signals 210 transmitted by the first UE 115-a. Parameters associated with the sensing signals 210 which may be selectively adjusted may include, but are not limited to, the set of time resources used for transmission of the sensing signals 210, the set of frequency resources used for transmission of the sensing signals 210, a transmit power associated with the sensing signals 210, a beam direction associated with the sensing signals 210, or any combination thereof. For example, the configuration message 220-c may include an indication for the first UE 115-a to selectively decrease a transmit power by which the sensing signals 210 are transmitted. In this regard, the base station 105-a may cause the first UE 115-a to adjust the parameters associated with the sensing signals 210 in order to eliminate or reduce interference at the second UE 115-b which is attributable to sensing signals 210 transmitted by the first UE 115-a.

By way of another example, as noted previously herein, the base station 105-a may determine, based on the first storage object associated with the first sensing application, that a UE 115 (e.g., the second UE 115-a) included within the first storage object is within a range of the first set of sensing signals 210-a associated with the first sensing application. In this example, the configuration message 220-c may include an indication for the first UE 115-a to selectively adjust a first set of sensing signal parameters associated with the first set of sensing signals 210-a of the sensing application based on determining that a UE 115 included within the first storage object is within the range of the first set of sensing signals 210-a associated with the first sensing application.

Similarly, the base station 105-a may transmit a configuration message 220-d to the second UE 115-b. In some aspects, the configuration message 220-d may include an indication for the second UE 115-b to selectively adjust one or more downlink reception parameters used by the second UE 115-b. For example, the configuration message 220-d may include an indication for the second UE 115-b to selectively adjust a set of time resources and/or a set of frequency resources used for downlink reception. In such cases, the base station 105-a may cause the second UE 115-b to adjust the downlink reception parameters in order to eliminate or reduce interference at the second UE 115-b which is attributable to sensing signals 210 transmitted by the first UE 115-a. For instance, the base station 105-a may cause the second UE 115-b to adjust one or more downlink reception parameters such that a set of downlink reception resources do not overlap with the set of sensing resources used by the first UE 115-a for transmission of the sensing signals 210.

Techniques described herein may enable the second UE 115-b and/or the base station 105-a of a wireless communications system 200 to estimate interference attributable to sensing signals 210 transmitted by the first UE 115-a. Moreover, techniques described herein may enable the base station 105-a to adjust parameters associated with the sensing signals 210 transmitted by the first UE 115-a, parameters associated with signal reception used by the second UE 115-b, or both, to reduce interference attributable to the sensing signals 210. Accordingly, techniques described herein may facilitate the use of sensing applications while reducing interference attributable to the sensing applications, thereby improving the efficiency and reliability of wireless communications within the wireless communications system 200.

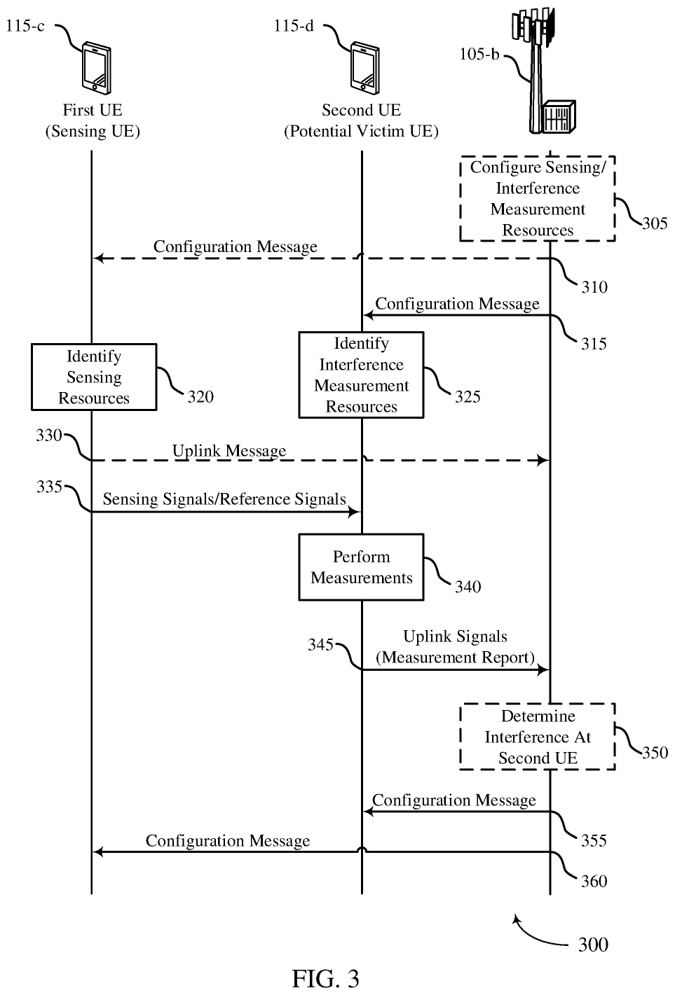

FIG. 3 illustrates an example of a process flow 300 that supports interference measurement of sensing signals in accordance with aspects of the present disclosure. In some examples, process flow 300 may implement, or be implemented by, aspects of wireless communications system 100 or 200. For example, the process flow 300 may illustrate a base station 105-b configuring sensing resources and/or measurement resources, receiving uplink signals from a second UE 115-d, determining interference at the second UE 115-d, and transmitting configuration messages to a first UE 115-c and/or the second UE 115-d based on the determined interference, as described with reference to FIGS. 1-2.

In some cases, process flow 300 may include a first UE 115-c, a second UE 115-d, and a base station 105-b, which may be examples of corresponding devices as described herein. The first UE 115-c and the second UE 115-d illustrated in FIG. 3 may be examples of the first UE 115-a and the second UE 115-b, respectively, illustrated in FIG. 2. In this regard, the first UE 115-c may include an example of a “sensing” UE 115-c, and the second UE 115-d may include an example of a “victim” UE 115-d. Similarly, the base station 105-b illustrated in FIG. 3 may be an example of the base station 105-a illustrated in FIG. 2. In some aspects, the first UE 115-c and the second UE 115-d may communicate over a sidelink communication link, such as the communication link 205-c illustrated in FIG. 2.

In some examples, the operations illustrated in process flow 300 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 305, the base station 105-b may identify (e.g., configure, determine) a set of interference measurement resources, a set of sensing resources, or both. In some aspects, the set of sensing resources may include a set of time and frequency resources to be used by the first UE 115-c to transmit sensing signals associated with one or more sensing applications. Similarly, the set of interference measurement resources may include a set of time resources and a set of frequency resources associated with determining interference attributable to sensing signals transmitted by the first UE 115-c. The set of interference measurement resources may be associated with signals (e.g., sensing signals, uplink signals, reference signals, sidelink signals) transmitted by the first UE 115-c. In this regard, the set of interference measurement signals may be used by the second UE 115-d to measure signals received from the first UE 115-c. For example, the set of interference measurement resources may be associated with the set of sensing resources to be used by the first UE 115-c for transmission of the sensing signals.

At 310, the base station 105-b may transmit a configuration message to the first UE 115-c, where the configuration message includes an indication (e.g., a configuration) of the set of sensing resources. In this regard, the configuration message transmitted at 310 may indicate a set of time resources and a set of sensing resources associated with the set of sensing resources which are to be used by the first UE 115-c for transmission of sensing signals. In some aspects, the base station 105-b may transmit the configuration message at 310 based on identifying (e.g., configuring) the set of sensing resources at 305.

In some aspects, the base station 105-b may additionally identify that a first subcarrier spacing associated with the set of sensing resources and/or the set of interference measurement resources is larger than a second subcarrier spacing associated with an active BWP of the second UE 115-d. In such cases, the configuration message transmitted to the first UE 115-c at 310 may include a sensing signal adjustment such that less than all symbols configured for the sensing signals are used for transmission of the sensing signals. Moreover, the configuration message transmitted to the first UE 115-c at 310 may include a subcarrier spacing adjustment such that the first subcarrier spacing is updated to equal the second subcarrier spacing. In some aspects, the base station 105-b may configure the set of sensing resources such that a starting position and a number of symbols in the sensing signals are not multiples of the first subcarrier spacing divided by the second subcarrier spacing.

At 315, the base station 105-b may transmit a configuration message to the second UE 115-d, where the configuration message includes an indication (e.g., a configuration) of the set of interference measurement resources. The set of interference measurement resources may be associated with sensing signals transmitted by the first UE 115-c. In this regard, the configuration message transmitted at 315 may indicate a set of time resources and a set of sensing resources associated with the set of sensing resources which are to be used by the first UE 115-c for transmission of sensing signals. In some aspects, the base station 105-b may transmit the configuration message at 315 based on identifying (e.g., configuring) the set of interference measurement resources at 305.

In some aspects, the configuration message transmitted from the base station 105-b to the second UE 115-d at 315 may include information indicative that the set of interference measurement resources include an entire reception bandwidth associated with the second UE 115-d. In this regard, the configuration message transmitted 315 may include an indication that the second UE 115-d is to perform measurements associated with sensing signals transmitted by the first UE 115-c using an entire reception bandwidth associated with the second UE 115-d. Additionally or alternatively, the configuration message transmitted from the base station 105-b to the second UE 115-d at 315 may include an indication that the set of interference measurement resources include a set of CLI measurement resources for measuring interference associated with sensing signals transmitted by the first UE 115-c.

For example, the configuration message transmitted at 315 may include an indication that the set of interference measurement resources include a set of CLI measurement resources for measuring one or more parameters (e.g., RSSI) of the sensing signals transmitted by the first UE 115-c. By way of another example, the configuration message transmitted at 315 may include an indication that the set of interference measurement resources include a set of CLI measurement resources for measuring one or more parameters associated with reference signals transmitted by the first UE 115-c.

In some aspects, the set of interference measurement resources (e.g., CLI measurement resources) may have a lesser priority than a set of downlink resources used by the second UE 115-d when the set of interference measurement resources (e.g., CLI measurement resources) at least partially overlap with the set of downlink resources. For example, in cases where the set of measurement interference resources include CLI measurement resources for measuring interference associated with the sensing signals transmitted by the first UE 115-c, the set of CLI measurement resources may have a lesser priority than a set of downlink resources used by the second UE 115-d which at least partially overlap with the set of CLI measurement resources. In some aspects, the configuration message indicating relative priority between the set of interference measurement resources (e.g., CLI measurement resources) may be indicated in the configuration message transmitted at 315.

At 320, the first UE 115-c may identify the set of sensing resources to be used for transmission of sensing signals. In some aspects, the first UE 115-c may identify the set of sensing resources at 320 based on the configuration message received at 310. Additionally or alternatively, the first UE 115-c may determine the set of sensing signal resources associated with sensing signals of a sensing application on its own. For example, in some cases, the first UE 115-c may be preconfigured with the set of sensing resources, or may select the set of sensing resources without configuration from the base station 105-b. In such cases, the first UE 115-c may transmit an uplink message (e.g., the uplink message transmitted at 330) to the base station, where the uplink message indicates the set of sensing resources to be used for transmission of sensing signals. In this example, the base station 105-b may identify the set of sensing resources to be used for transmission of sensing signals based on the uplink message received at 330.

At 325, the second UE 115-d may identify the set of interference measurement resources associated with sensing signals transmitted by the first UE 115-c. In some aspects, the second UE 115-d may identify the set of sensing resources at 325 based on the configuration message received at 315. In some aspects, the second UE 115-d may determine that the set of interference measurement resources are associated with sensing signals transmitted by the first UE 115-c, reference signals transmitted by the first UE 115-c, or both. For example, the second UE 115-d may determine that the set of interference measurement resources include a set of CLI measurement resources for measuring one or more parameters (e.g., RSSI) associated with the sensing signals transmitted by the first UE 115-c based on the configuration message received at 315. By way of another example, the second UE 115-d may determine that the set of interference measurement resources include a set of CLI measurement resources for measuring one or more parameters associated with reference signals transmitted by the first UE 115-c based on the configuration message received at 315.

In some aspects, the second UE 115-d may determine a relative priority of the set of interference measurement resources relative to other sets of resources used by the second UE 115-d. For example, the second UE 115-d may determine that the set of interference measurement resources (e.g., CLI measurement resources) have a lesser priority than a set of downlink resources used by the second UE 115-d when the set of interference measurement resources at least partially overlap with the set of downlink resources. In this example, the second UE 115-d may determine that it is to refrain from performing measurements using the set of interference measurement resources when the set of interference measurement resources at least partially overlap with the set of downlink resources, as will be discussed in further detail herein.

In some aspects, the second UE 115-d may additionally determine that the first subcarrier spacing associated with the set of sensing resources and/or the set of interference measurement resources is larger than a subcarrier spacing associated with an active BWP of the second UE 115-d. In such cases, the second UE 115-d may determine that that less than all symbols configured for the sensing signals are used for transmission of the sensing signals. Additionally or alternatively, the second UE 115-d may determine that a starting position and a number of symbols in the sensing signals are not multiples of the first subcarrier spacing divided by the second subcarrier spacing.

At 335, the second UE 115-d may receive one or more signals from the first UE 115-c. In some aspects, the signals received by the second UE 115-d at 335 may be associated with the set of interference measurement signals determined at 325. In this regard, the one or more signals received from the first UE 115-c may be received within the set of interference measurement resources (e.g., within the set of time resources and the set of frequency resources associated with the set of interference measurement resources). The one or more signals received from the first UE 115-c may include sensing signals, reference signals, sidelink signals, or any combination thereof. For example, in cases where the set of interference measurement resources include a set of CLI measurement resources for measuring interference and/or RSSI indicators associated with sensing signals transmitted by the first UE 115-c, the one or more signals received at 335 may include sensing signals. By way of another example, in cases where the set of interference measurement resources include a set of CLI measurement resources for measuring one or more parameters associated with reference signals transmitted by the first UE 115-c, the one or more signals received at 335 may include reference signals.

At 340, the second UE 115-d may perform one or more measurements on the one or more signals received from the first UE 115-c. The one or more measurements may include, but are not limited to, RSSI measurements, RSRP measurements, RSRQ measurements, SNR measurements, SINR measurements, or any combination thereof. In some aspects, the second UE 115-d may perform the one or more measurements at 340 based on receiving the configuration message at 315, identifying the set of interference measurement resources at 325, or both. In some cases, the second UE 115-d may generate a measurement report based on the one or more measurements.

For example, in cases where the set of interference measurement resources include a set of CLI measurement resources for measuring an RSSI indicator associated with sensing signals transmitted by the first UE 115-c, the second UE 115-d may perform one or more measurements to determine an RSSI indicator associated with the sensing signals. By way of another example, in cases where the set of interference measurement resources include a set of CLI measurement resources for measuring one or more parameters associated with reference signals transmitted by the first UE 115-c, the second UE 115-d may perform one or more measurements to determine one or more parameters (e.g., RSSI, RSRP, RSRQ, SNR, SINR) associated with the reference signals.

As noted previously herein, the set of interference measurement resources (e.g., CLI measurement resources) may have a lesser priority than other sets of resources (e.g., a set of downlink resources) used by the second UE 115-d. In particular, the set of interference measurement resources may have a lesser priority than a set of downlink resources used by the second UE 115-d which at least partially overlap the set of interference measurement resources. For example, the second UE 115-d may determine that the set of interference measurement resources (e.g., CLI measurement resources) at least partially overlap with a set of downlink resources used by the second UE 115-d. The set of interference measurement resources may overlap with the set of downlink resources in the time domain, the frequency domain, or both. In this example, the second UE 115-d may refrain from performing the measurements using the set of interference measurement resources (e.g., CLI measurement resources) based on determining that the set of interference measurement resources (e.g., CLI measurement resources) at least partially overlap with a set of downlink resources. Moreover, the second UE 115-d may receive one or more downlink messages from the base station 105-b using the set of downlink resources based on determining that the set of interference measurement resources (e.g., CLI measurement resources) at least partially overlap with a set of downlink resources, refraining from performing the measurements, or both.

At 345, the second UE 115-d may transmit one or more signals to the base station 105-b. In some cases, the second UE 115-d may transmit the one or more signals to the base station 105-b based on receiving the configuration message at 315, identifying the interference measurement resources at 325, receiving the signals from the first UE 115-c at 335, performing the measurements at 340, or any combination thereof. For example, in some cases, the one or more signals transmitted by the second UE 115-d at 340 may include a measurement report based on performing the one or more measurements. In this regard, the second UE 115-d may report, to the base station 105-b, various parameters associated with sensing signals and/or reference signals received from the first UE 115-c.

At 350, the base station 105-b may determine interference at the second UE 115-d which is associated with sensing signals transmitted by the first UE 115-c. In some aspects, the base station 105-b may determine the interference experienced by the second UE 115-d at 350 based on the set of sensing resources, the set of interference measurement resources, or both. Additionally, the base station 105-b may determine the interference experienced by the second UE 115-d at 350 based on receiving the uplink message at 330, receiving the uplink signals (e.g., measurement report) at 345, or both.

Additionally or alternatively, the base station 105-b may determine interference experienced by the second UE 115-d based on relative positions of the first UE 115-c and the second UE 115-d with respect to one another. In particular, the base station 105-b may estimate pathloss between the first UE 115-c and the second UE 115-d based on the relative positions of the first UE 115-c and the second UE 115-d with respect to one another, and may determine the interference experienced by the second UE 115-d based on the estimated pathloss.

For example, in some cases, the base station 105-b may determine a relative position of the second UE 115-d with respect to (e.g., relative to) the first UE 115-c. For instance, in some cases, the uplink signals received from the second UE 115-d at 345 may include an indication of the position of the second UE 115-d. Similarly, uplink signals received from the first UE 115-c (e.g., uplink message received at 330, other uplink signals) may include an indication of the position of the first UE 115-c. In this example, the base station 105-b may determine the relative position of the second UE 115-d with respect to the first UE 115-c based on the indications of positions of the first UE 115-c and the second UE 115-d. Additionally, the base station 105-b may determine a pathloss between the first UE 115-c and the second UE 115-d based on the relative position of the second UE 115-d with respect to the first UE 115-c. In this regard, the base station 105-b may determine the interference experienced at the second UE 115-d which is attributable to sensing signals from the first UE 115-c based on the relative position of the second UE 115-d with respect to the first UE 115-c and the estimated pathloss between the first UE 115-c and the second UE 115-d.

In cases where the base station 105-b determines a relative position of the second UE 115-d with respect to the first UE 115-c, the base station 105-b may additionally include the relative position of the second UE 115-d in storage objects associated with various sensing applications supported by the first UE 115-c. For example, the first UE 115-c may include the relative position of the second UE 115-d in a first storage object associated with a first sensing application, and in a second storage object associated with a second sensing application. The storage objects may include any storage object known in the art including, but not limited to, a table, an index, a map, and the like. In some aspects, the first storage object and the second storage object may each additionally include other UEs 115 and respective other relative positions of the other UEs 115 with respect to the first UE 115-c. For example, the first storage object associated with the first sensing application may include a third UE 115 (not shown) and a relative position of the third UE 115 with respect to the first UE 115-c.

In some aspects, the base station 105-b may be configured to estimate interference and/or ranges of potential interference associated with each respective sensing application based on the storage objects associated with each respective sensing application. For example, the base station 105-b may determine, based on a first storage object associated with the first sensing application, that a UE 115 (e.g., the second UE 115-d) included within the first storage object is within a range of sensing signals associated with the first sensing application. By way of another example, the base station 105-b may determine, based on a second storage object associated with the second sensing application, that a UE 115 (e.g., the second UE 115-d) included within the second storage object is within a range of sensing signals associated with the second sensing application.

In some aspects, the base station 105-b may transmit a configuration message to the first UE 115-c, the second UE 115-d, or both, in order to manage (e.g., reduce, eliminate) the interference experienced by the second UE 115-d. In this regard, the base station 105-b may transmit a configuration message including an indication of a parameter adjustment pertaining to at least one of the sensing signals transmitted by the first UE 115-c, downlink reception performed by the second UE 115-d, or both. In particular, the base station 105-b may selectively adjust parameters associated with the respective sensing applications (e.g., first sensing application, second sensing application) based on a determining a UE 115 included in a respective storage objects is within range of the sensing signals associated with the respective sensing application.

At 355, the base station 105-b may transmit a configuration message to the second UE 115-d. In some aspects, the configuration message may include an indication for the second UE 115-d to selectively adjust one or more downlink reception parameters used by the second UE 115-d. For example, the configuration message may include an indication for the second UE 115-d to selectively adjust a set of time resources and/or a set of frequency resources used for downlink reception. In such cases, the base station 105-b may cause the second UE 115-d to adjust the downlink reception parameters in order to eliminate or reduce interference at the second UE 115-d which is attributable to sensing signals transmitted by the first UE 115-c. For instance, the base station 105-b may cause the second UE 115-d to adjust one or more downlink reception parameters such that a set of downlink reception resources do not overlap with the set of sensing resources used by the first UE 115-c for transmission of the sensing signals.

At 360, the base station 105-b may transmit a configuration message to the first UE 115-c. In some aspects, the configuration message may include an indication for the first UE 115-c to selectively adjust one or more parameters associated with the sensing signals transmitted by the first UE 115-c. Parameters associated with the sensing signals which may be selectively adjusted may include, but are not limited to, the set of time resources used for transmission of the sensing signals, the set of frequency resources used for transmission of the sensing signals, a transmit power associated with the sensing signals, a beam direction associated with the sensing signals, or any combination thereof. For example, the configuration message may include an indication for the first UE 115-c to selectively decrease a transmit power by which the sensing signals are transmitted. In this regard, the base station 105-b may cause the first UE 115-c to adjust the parameters associated with the sensing signals in order to eliminate or reduce interference at the second UE 115-d which is attributable to sensing signals transmitted by the first UE 115-c.

By way of another example, as noted previously herein, the base station 105-b may determine, based on the first storage object associated with the first sensing application, that a UE 115 (e.g., the second UE 115-d) included within the first storage object is within a range of sensing signals associated with the first sensing application. In this example, the configuration message transmitted at 360 may include an indication for the first UE 115-c to selectively adjust a first set of sensing signal parameters associated with the first sensing application based on determining that a UE 115 included within the first storage object is within the range of sensing signals associated with the first sensing application.

Techniques described herein may enable the second UE 115-d and/or the base station 105-b of a wireless communications system (e.g., wireless communications systems 100 or 200) to estimate interference attributable to sensing signals transmitted by the first UE 115-c. Moreover, techniques described herein may enable the base station 105-b to adjust parameters associated with the sensing signals transmitted by the first UE 115-c, parameters associated with signal reception used by the second UE 115-d, or both, to reduce interference attributable to the sensing signals. Accordingly, techniques described herein may facilitate the use of sensing applications while reducing interference attributable to the sensing applications, thereby improving the efficiency and reliability of wireless communications within the wireless communications system (e.g., wireless communications systems 100 or 200).

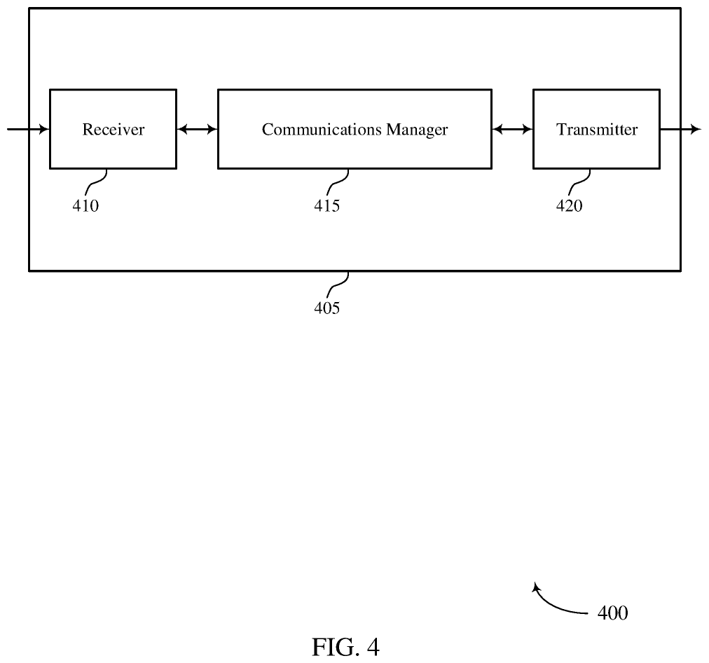

FIG. 4 shows a block diagram 400 of a device 405 that supports interference measurement of sensing signals in accordance with aspects of the present disclosure. The device 405 may be an example of aspects of a UE 115 as described herein. The device 405 may include a receiver 410, a communications manager 415, and a transmitter 420. The device 405 may also include a processor. Each of these components may be in communication with one another (e.g., via one or more buses).

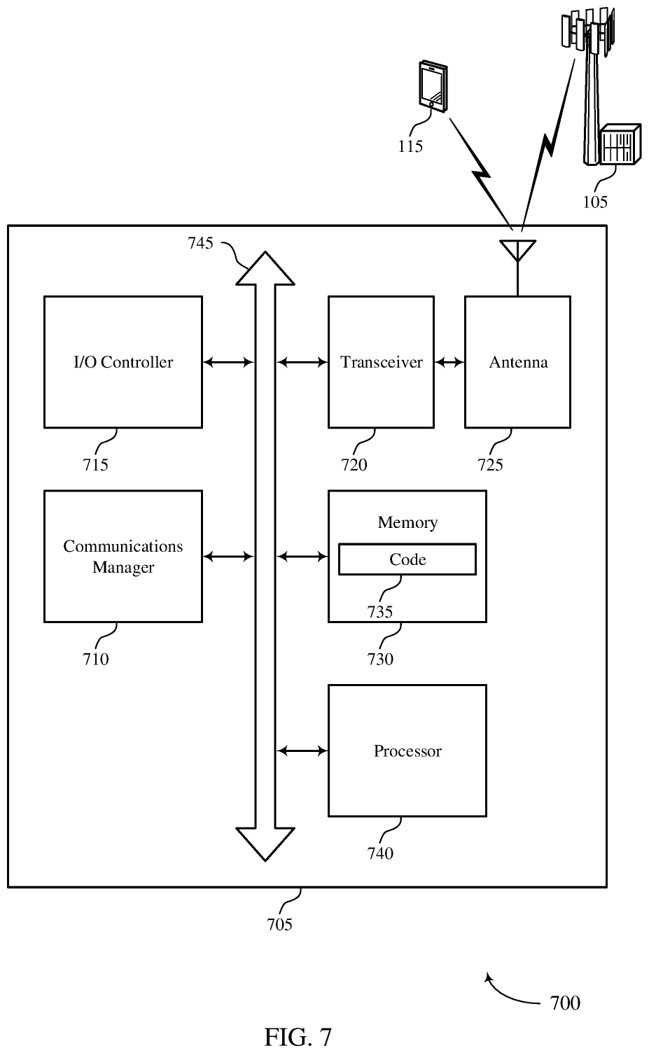

The receiver 410 may receive information such as packets, user data, or control information associated with various information channels (e.g., control channels, data channels, and information related to interference measurement of sensing signals, etc.). Information may be passed on to other components of the device 405. The receiver 410 may be an example of aspects of the transceiver 720 described with reference to FIG. 7. The receiver 410 may utilize a single antenna or a set of antennas.

The communications manager 415 may receive, from a base station, a first configuration message indicating a set of interference measurement resources associated with a set of sensing resources to be used by a second UE for transmission of sensing signals, perform one or more measurements on one or more signals received from the second UE within the set of interference measurement resources, and transmit, to the base station, a measurement report based on the one or more measurements. The communications manager 415 may be an example of aspects of the communications manager 710 described herein.

The actions performed by the communications manager 415 as described herein may be implemented to realize one or more potential advantages. For example, signaling performed by a victim UE 115 may enable a base station 105 to determine interference experienced by the victim UE 115 which is attributable to sensing signals transmitted by a sensing UE 115. In this regard, signaling performed by the victim UE 115 may enable the base station 105 to adjust parameters of the sensing UE 115 and/or victim UE 115 in order to reduce interference attributable to sensing signals. Accordingly, enabling improved sensing signal interference management may facilitate use of sensing applications while reducing interference attributable to the sensing applications, which may lead to more efficient and reliable wireless communications.

By enabling improved sensing signal interference management, a processor of the victim UE 115 (e.g., a processor controlling the receiver 410, the communications manager 415, the transmitter 420, etc.) may reduce processing resources used for wireless communications. For example, by improving sensing signal interference management, interference attributable to sensing signals may be reduced, thereby reducing a quantity of retransmissions which must be performed to communicate data within a wireless communications system. Reducing such interference and avoiding such retransmissions may correspondingly reducing a number of times the processor ramps up processing power and turns on processing units to handle uplink transmission and downlink reception.

The communications manager 415, or its sub-components, may be implemented in hardware, code (e.g., software or firmware) executed by a processor, or any combination thereof. If implemented in code executed by a processor, the functions of the communications manager 415, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 415, or its sub-components, may be physically located at various positions, including being distributed such that portions of functions are implemented at different physical locations by one or more physical components. In some examples, the communications manager 415, or its sub-components, may be a separate and distinct component in accordance with various aspects of the present disclosure. In some examples, the communications manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 420 may transmit signals generated by other components of the device 405. In some examples, the transmitter 420 may be collocated with a receiver 410 in a transceiver module. For example, the transmitter 420 may be an example of aspects of the transceiver 720 described with reference to FIG. 7. The transmitter 420 may utilize a single antenna or a set of antennas.

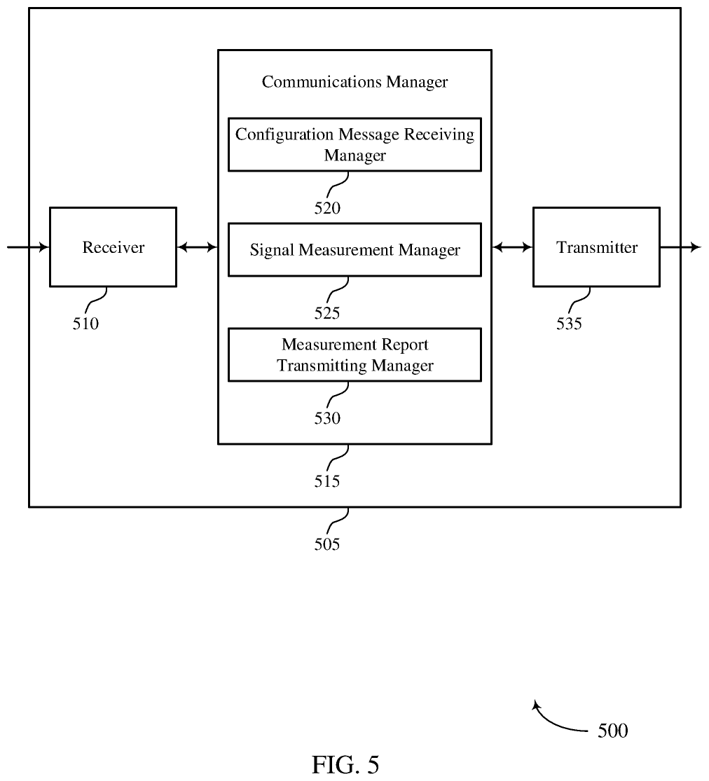

FIG. 5 shows a block diagram 500 of a device 505 that supports interference measurement of sensing signals in accordance with aspects of the present disclosure. The device 505 may be an example of aspects of a device 405, or a UE 115 as described herein. The device 505 may include a receiver 510, a communications manager 515, and a transmitter 535. The device 505 may also include a processor. Each of these components may be in communication with one another (e.g., via one or more buses).

The receiver 510 may receive information such as packets, user data, or control information associated with various information channels (e.g., control channels, data channels, and information related to interference measurement of sensing signals, etc.). Information may be passed on to other components of the device 505. The receiver 510 may be an example of aspects of the transceiver 720 described with reference to FIG. 7. The receiver 510 may utilize a single antenna or a set of antennas.

The communications manager 515 may be an example of aspects of the communications manager 415 as described herein. The communications manager 515 may include a configuration message receiving manager 520, a signal measurement manager 525, and a measurement report transmitting manager 530. The communications manager 515 may be an example of aspects of the communications manager 710 described herein.

The configuration message receiving manager 520 may receive, from a base station, a first configuration message indicating a set of interference measurement resources associated with a set of sensing resources to be used by a second UE for transmission of sensing signals.

The signal measurement manager 525 may perform one or more measurements on one or more signals received from the second UE within the set of interference measurement resources.

The measurement report transmitting manager 530 may transmit, to the base station, a measurement report based on the one or more measurements.

The transmitter 535 may transmit signals generated by other components of the device 505. In some examples, the transmitter 535 may be collocated with a receiver 510 in a transceiver module. For example, the transmitter 535 may be an example of aspects of the transceiver 720 described with reference to FIG. 7. The transmitter 535 may utilize a single antenna or a set of antennas.

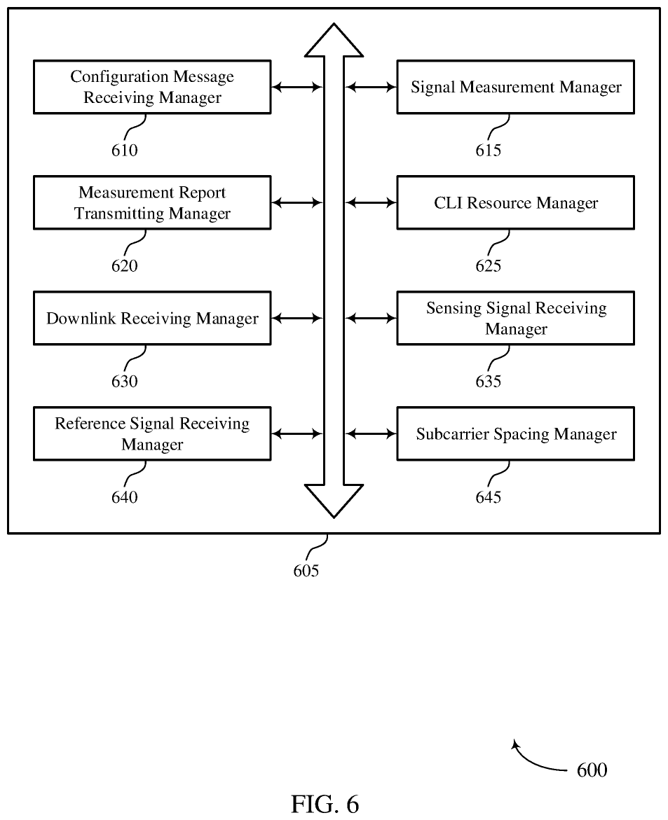

FIG. 6 shows a block diagram 600 of a communications manager 605 that supports interference measurement of sensing signals in accordance with aspects of the present disclosure. The communications manager 605 may be an example of aspects of a communications manager 415, a communications manager 515, or a communications manager 710 described herein. The communications manager 605 may include a configuration message receiving manager 610, a signal measurement manager 615, a measurement report transmitting manager 620, a CLI resource manager 625, a downlink receiving manager 630, a sensing signal receiving manager 635, a reference signal receiving manager 640, and a subcarrier spacing manager 645. Each of these modules may communicate, directly or indirectly, with one another (e.g., via one or more buses).

The configuration message receiving manager 610 may receive, from a base station, a first configuration message indicating a set of interference measurement resources associated with a set of sensing resources to be used by a second UE for transmission of sensing signals. In some examples, the configuration message receiving manager 610 may receive, from the base station and based on transmission of the measurement report, a second configuration message indicating that the first UE is to selectively adjust one or more downlink reception parameters used by the first UE.

In some examples, the configuration message receiving manager 610 may receive, from the base station via the first configuration message, an indication that the set of interference measurement resources include a set of cross-link interference measurement resources for measuring interference associated with the sensing signals transmitted by the second UE. In some examples, the configuration message receiving manager 610 may receive, from the base station via the first configuration message, an indication that the set of interference measurement resources include a set of cross-link interference measurement resources for measuring a received signal strength indicator of the sensing signals transmitted by the second UE. In some examples, the configuration message receiving manager 610 may receive, from the base station via the first configuration message, an indication that the set of interference measurement resources include a set of cross-link interference measurement resources for measuring a one or more parameters associated with reference signals transmitted by the first UE. In some examples, the configuration message receiving manager 610 may receive, from the base station, information indicative that the set of interference measurement resources include an entire reception bandwidth associated with the first UE. In some cases, the set of interference measurement resources include a set of time resources and a set of frequency resources.

The signal measurement manager 615 may perform one or more measurements on one or more signals received from the second UE within the set of interference measurement resources. In some examples, the signal measurement manager 615 may refrain from performing measurements using the set of cross-link interference measurement resources based on determining that the cross-link interference measurement resources at least partially overlap with the set of downlink resources.

The measurement report transmitting manager 620 may transmit, to the base station, a measurement report based on the one or more measurements.

The CLI resource manager 625 may determine that the set of cross-link interference measurement resources at least partially overlap with the set of downlink resources used by the first UE. In some cases, the set of cross-link interference measurement resources for measuring interference associated with the sensing signals transmitted by the second UE have a lesser priority than a set of downlink resources used by the first UE which at least partially overlap with the set of cross-link interference measurement resources.

The downlink receiving manager 630 may receive one or more downlink messages using the set of downlink resources based on determining that the cross-link interference measurement resources at least partially overlap with the set of downlink resources.

The sensing signal receiving manager 635 may receive the sensing signals transmitted by the second UE, where the one or more measurements are performed on the sensing signal based on the indication that the set of interference measurement resources include a set of cross-link interference measurement resources for measuring a received signal strength indicator of the sensing signals.

The reference signal receiving manager 640 may receive reference signals transmitted by the second UE, where the one or more measurements are performed on the reference signals based on the indication that the set of interference measurement resources include a set of cross-link interference measurement resources for measuring a one or more parameters associated with the reference signals.

The subcarrier spacing manager 645 may identify that a first subcarrier spacing associated with the set of sensing resources is larger than a second subcarrier spacing associated with an active bandwidth part of the second UE. In some examples, the subcarrier spacing manager 645 may identify that less than all symbols configured for the sensing signals are used for transmission of the sensing signals. In some examples, the subcarrier spacing manager 645 may identify that a starting position and a number of symbols in the sensing signals are not multiples of the first subcarrier spacing divided by the second subcarrier spacing.

FIG. 7 shows a diagram of a system 700 including a device 705 that supports interference measurement of sensing signals in accordance with aspects of the present disclosure. The device 705 may be an example of or include the components of device 405, device 505, or a UE 115 as described herein. The device 705 may include components for bi-directional voice and data communications including components for transmitting and receiving communications, including a communications manager 710, an I/O controller 715, a transceiver 720, an antenna 725, memory 730, and a processor 740. These components may be in electronic communication via one or more buses (e.g., bus 745).

The communications manager 710 may receive, from a base station, a first configuration message indicating a set of interference measurement resources associated with a set of sensing resources to be used by a second UE for transmission of sensing signals, perform one or more measurements on one or more signals received from the second UE within the set of interference measurement resources, and transmit, to the base station, a measurement report based on the one or more measurements.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described above. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the wireless device may include a single antenna 725. However, in some cases the device may have more than one antenna 725, which may be capable of concurrently transmitting or receiving multiple wireless transmissions.

The memory 730 may include random-access memory (RAM) and read-only memory (ROM). The memory 730 may store computer-readable, computer-executable code 735 including instructions that, when executed, cause the processor to perform various functions described herein. In some cases, the memory 730 may contain, among other things, a basic I/O system (BIOS) which may control basic hardware or software operation such as the interaction with peripheral components or devices.

The processor 740 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting interference measurement of sensing signals).

The code 735 may include instructions to implement aspects of the present disclosure, including instructions to support wireless communications. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

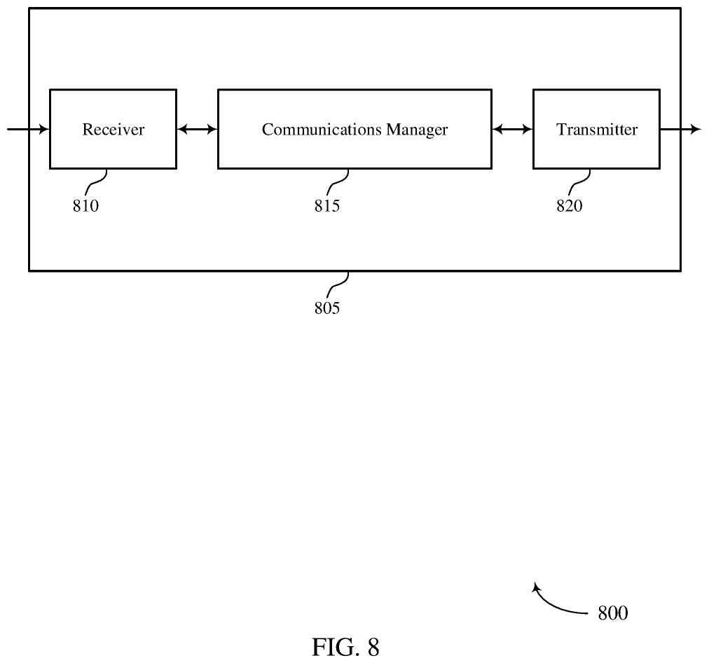

FIG. 8 shows a block diagram 800 of a device 805 that supports interference measurement of sensing signals in accordance with aspects of the present disclosure. The device 805 may be an example of aspects of a base station 105 as described herein. The device 805 may include a receiver 810, a communications manager 815, and a transmitter 820. The device 805 may also include a processor. Each of these components may be in communication with one another (e.g., via one or more buses).

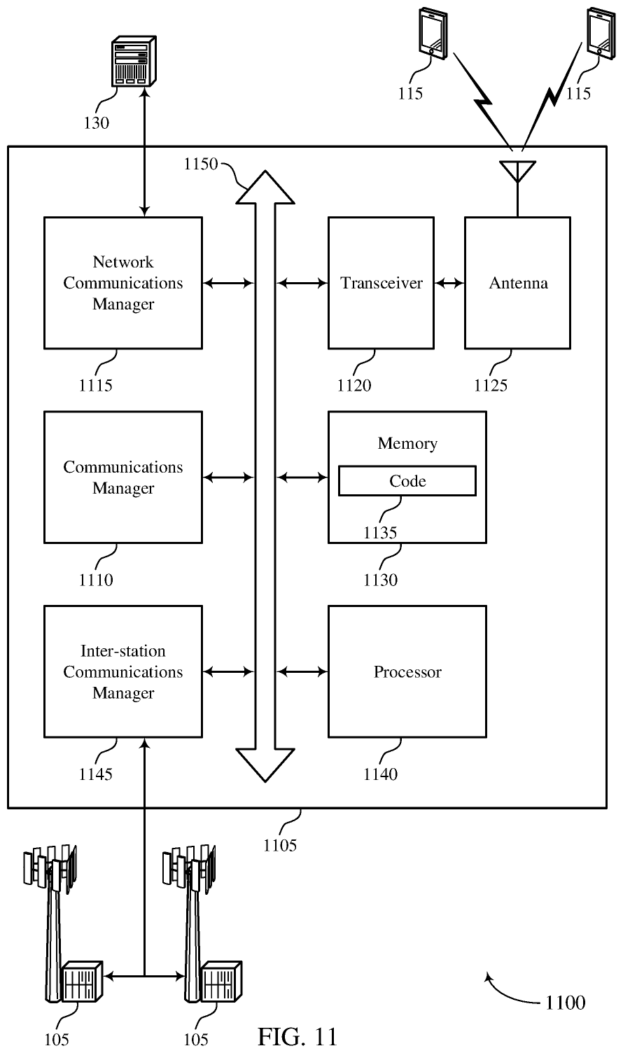

The receiver 810 may receive information such as packets, user data, or control information associated with various information channels (e.g., control channels, data channels, and information related to interference measurement of sensing signals, etc.). Information may be passed on to other components of the device 805. The receiver 810 may be an example of aspects of the transceiver 1120 described with reference to FIG. 11. The receiver 810 may utilize a single antenna or a set of antennas.

The communications manager 815 may identify a set of sensing resources to be used by a first UE for transmission of sensing signals, receive one or more uplink signals from a second UE, determine interference at the second UE associated with the sensing signals transmitted by the first UE based on the set of sensing resources, the one or more uplink signals received from the second UE, or both, and transmit, based on determination of the interference at the second UE, a configuration message to at least one of the first UE or the second UE, the configuration message including an indication of a parameter adjustment pertaining to at least one of transmission of the sensing signals by the first UE or downlink reception by the second UE. The communications manager 815 may be an example of aspects of the communications manager 1110 described herein.

The actions performed by the communications manager 815 as described herein may be implemented to realize one or more potential advantages. For example, signaling performed by a victim UE 115 and base station 105 may enable the base station 105 to determine interference experienced by the victim UE 115 which is attributable to sensing signals transmitted by a sensing UE 115. The communications manager 815 may enable the base station 105 to adjust parameters of the sensing UE 115 and/or victim UE 115 in order to reduce interference attributable to sensing signals. Accordingly, enabling improved sensing signal interference management may facilitate use of sensing applications while reducing interference attributable to the sensing applications, which may lead to more efficient and reliable wireless communications.

By enabling improved sensing signal interference management, a processor of the base station 105 (e.g., a processor controlling the receiver 810, the communications manager 815, the transmitter 820, etc.) may reduce processing resources used for wireless communications. For example, by improving sensing signal interference management, interference attributable to sensing signals may be reduced, thereby reducing a quantity of retransmissions which must be performed to communicate data within a wireless communications system. Reducing such interference and avoiding such retransmissions may correspondingly reducing a number of times the processor ramps up processing power and turns on processing units to handle uplink transmission and downlink reception.

The communications manager 815, or its sub-components, may be implemented in hardware, code (e.g., software or firmware) executed by a processor, or any combination thereof. If implemented in code executed by a processor, the functions of the communications manager 815, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 815, or its sub-components, may be physically located at various positions, including being distributed such that portions of functions are implemented at different physical locations by one or more physical components. In some examples, the communications manager 815, or its sub-components, may be a separate and distinct component in accordance with various aspects of the present disclosure. In some examples, the communications manager 815, or its sub-components, may be combined with one or more other hardware components, including but not limited to an I/O component, a transceiver, a network server, another computing device, one or more other components described in the present disclosure, or a combination thereof in accordance with various aspects of the present disclosure.

The transmitter 820 may transmit signals generated by other components of the device 805. In some examples, the transmitter 820 may be collocated with a receiver 810 in a transceiver module. For example, the transmitter 820 may be an example of aspects of the transceiver 1120 described with reference to FIG. 11. The transmitter 820 may utilize a single antenna or a set of antennas.

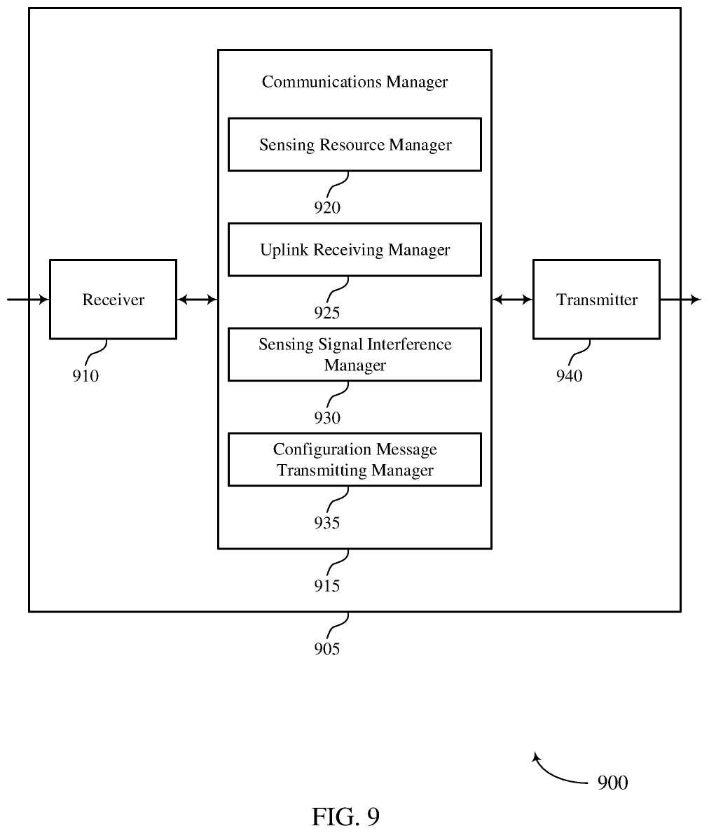

FIG. 9 shows a block diagram 900 of a device 905 that supports interference measurement of sensing signals in accordance with aspects of the present disclosure. The device 905 may be an example of aspects of a device 805, or a base station 105 as described herein. The device 905 may include a receiver 910, a communications manager 915, and a transmitter 940. The device 905 may also include a processor. Each of these components may be in communication with one another (e.g., via one or more buses).

The receiver 910 may receive information such as packets, user data, or control information associated with various information channels (e.g., control channels, data channels, and information related to interference measurement of sensing signals, etc.). Information may be passed on to other components of the device 905. The receiver 910 may be an example of aspects of the transceiver 1120 described with reference to FIG. 11. The receiver 910 may utilize a single antenna or a set of antennas.

The communications manager 915 may be an example of aspects of the communications manager 815 as described herein. The communications manager 915 may include a sensing resource manager 920, an uplink receiving manager 925, a sensing signal interference manager 930, and a configuration message transmitting manager 935. The communications manager 915 may be an example of aspects of the communications manager 1110 described herein.

The sensing resource manager 920 may identify a set of sensing resources to be used by a first UE for transmission of sensing signals.

The uplink receiving manager 925 may receive one or more uplink signals from a second UE.

The sensing signal interference manager 930 may determine interference at the second UE associated with the sensing signals transmitted by the first UE based on the set of sensing resources, the one or more uplink signals received from the second UE, or both.

The configuration message transmitting manager 935 may transmit, based on determination of the interference at the second UE, a configuration message to at least one of the first UE or the second UE, the configuration message including an indication of a parameter adjustment pertaining to at least one of transmission of the sensing signals by the first UE or downlink reception by the second UE.

The transmitter 940 may transmit signals generated by other components of the device 905. In some examples, the transmitter 940 may be collocated with a receiver 910 in a transceiver module. For example, the transmitter 940 may be an example of aspects of the transceiver 1120 described with reference to FIG. 11. The transmitter 940 may utilize a single antenna or a set of antennas.

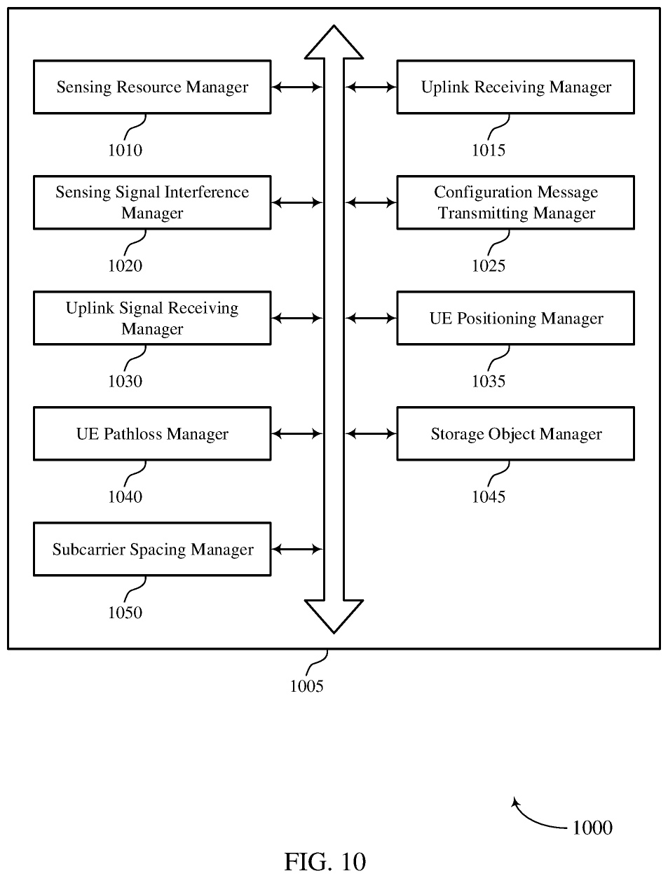

FIG. 10 shows a block diagram 1000 of a communications manager 1005 that supports interference measurement of sensing signals in accordance with aspects of the present disclosure. The communications manager 1005 may be an example of aspects of a communications manager 815, a communications manager 915, or a communications manager 1110 described herein. The communications manager 1005 may include a sensing resource manager 1010, an uplink receiving manager 1015, a sensing signal interference manager 1020, a configuration message transmitting manager 1025, an uplink signal receiving manager 1030, a UE positioning manager 1035, a UE pathloss manager 1040, a storage object manager 1045, and a subcarrier spacing manager 1050. Each of these modules may communicate, directly or indirectly, with one another (e.g., via one or more buses).

The sensing resource manager 1010 may identify a set of sensing resources to be used by a first UE for transmission of sensing signals. In some examples, the sensing resource manager 1010 may transmit, to the first UE, a configuration for the set of sensing resources to be used for transmission of the sensing signals. In some cases, the set of sensing resources include a set of time resources and a set of frequency resources.

The uplink receiving manager 1015 may receive one or more uplink signals from a second UE. In some examples, the uplink receiving manager 1015 may receive, from the first UE, an uplink message indicating the set of sensing resources to be used for transmission of the sensing signals.

The sensing signal interference manager 1020 may determine interference at the second UE associated with the sensing signals transmitted by the first UE based on the set of sensing resources, the one or more uplink signals received from the second UE, or both. In some examples, the sensing signal interference manager 1020 may determine the interference at the second UE based on the relative position.

The configuration message transmitting manager 1025 may transmit, based on determination of the interference at the second UE, a configuration message to at least one of the first UE or the second UE, the configuration message including an indication of a parameter adjustment pertaining to at least one of transmission of the sensing signals by the first UE or downlink reception by the second UE. In some examples, the configuration message transmitting manager 1025 may transmit, to the second UE, a second configuration message indicating a set of interference measurement resources associated with the sensing signals transmitted by the first UE. In some examples, the configuration message transmitting manager 1025 may transmit, to the second UE via the second configuration message, information indicative that the set of interference measurement resources include an entire reception bandwidth associated with the second UE.

In some examples, the configuration message transmitting manager 1025 may transmit, to the second UE via the second configuration message, an indication that the set of interference measurement resources include a set of cross-link interference measurement resources for measuring interference associated with the sensing signals transmitted by the first UE. In some examples, the configuration message transmitting manager 1025 may transmit, to the first UE, a first configuration message including an indication to selectively adjust one or more parameters associated with the sensing signals transmitted by the first UE. In some examples, the configuration message transmitting manager 1025 may transmit, to the second UE, a second configuration message including an indication to selectively adjust one or more downlink reception parameters used by the second UE. In some examples, the configuration message transmitting manager 1025 may include, in the configuration message transmitted to the first UE, a sensing signal adjustment such that less than all symbols configured for the sensing signals are used for transmission of the sensing signals. In some examples, the configuration message transmitting manager 1025 may include, in the configuration message transmitted to the first UE, a subcarrier spacing adjustment such that the first subcarrier spacing is updated to equal the second subcarrier spacing.

In some cases, the set of cross-link interference measurement resources for measuring interference associated with the sensing signals transmitted by the first UE have a lesser priority than a set of downlink resources used by the second UE which at least partially overlap with the set of cross-link interference measurement resources. In some cases, the set of interference measurement resources include a set of cross-link interference measurement resources for measuring a received signal strength indicator of the sensing signals transmitted by the first UE. In some cases, the set of interference measurement resources include a set of cross-link interference measurement resources for measuring one or more parameters associated with reference signals transmitted by the first UE.

The uplink signal receiving manager 1030 may receive, from the second UE via the one or more uplink signals, a measurement report based on the set of interference measurement resources, where determining the interference at the second UE is based on receiving the measurement report.

The UE positioning manager 1035 may determine a relative position of the second UE with respect to the first UE. The UE pathloss manager 1040 may determine a pathloss between the first UE and the second UE. The storage object manager 1045 may include the second UE and the relative position of the second UE in a storage object that also includes other UEs and respective other relative positions in relation to the first UE.

The subcarrier spacing manager 1050 may identify that a first subcarrier spacing associated with the set of sensing resources is larger than a second subcarrier spacing associated with an active bandwidth part of the second UE. In some cases, a starting position and a number of symbols in the sensing signals are not multiples of the first subcarrier spacing divided by the second subcarrier spacing.

FIG. 11 shows a diagram of a system 1100 including a device 1105 that supports interference measurement of sensing signals in accordance with aspects of the present disclosure. The device 1105 may be an example of or include the components of device 805, device 905, or a base station 105 as described herein. The device 1105 may include components for bi-directional voice and data communications including components for transmitting and receiving communications, including a communications manager 1110, a network communications manager 1115, a transceiver 1120, an antenna 1125, memory 1130, a processor 1140, and an inter-station communications manager 1145. These components may be in electronic communication via one or more buses (e.g., bus 1150).

The communications manager 1110 may identify a set of sensing resources to be used by a first UE for transmission of sensing signals, receive one or more uplink signals from a second UE, determine interference at the second UE associated with the sensing signals transmitted by the first UE based on the set of sensing resources, the one or more uplink signals received from the second UE, or both, and transmit, based on determination of the interference at the second UE, a configuration message to at least one of the first UE or the second UE, the configuration message including an indication of a parameter adjustment pertaining to at least one of transmission of the sensing signals by the first UE or downlink reception by the second UE.

The network communications manager 1115 may manage communications with the core network (e.g., via one or more wired backhaul links). For example, the network communications manager 1115 may manage the transfer of data communications for client devices, such as one or more UEs 115.

The transceiver 1120 may communicate bi-directionally, via one or more antennas, wired, or wireless links as described above. For example, the transceiver 1120 may represent a wireless transceiver and may communicate bi-directionally with another wireless transceiver. The transceiver 1120 may also include a modem to modulate the packets and provide the modulated packets to the antennas for transmission, and to demodulate packets received from the antennas.

In some cases, the wireless device may include a single antenna 1125. However, in some cases the device may have more than one antenna 1125, which may be capable of concurrently transmitting or receiving multiple wireless transmissions.

The memory 1130 may include RAM, ROM, or a combination thereof. The memory 1130 may store computer-readable code 1135 including instructions that, when executed by a processor (e.g., the processor 1140) cause the device to perform various functions described herein. In some cases, the memory 1130 may contain, among other things, a BIOS which may control basic hardware or software operation such as the interaction with peripheral components or devices.

The processor 1140 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some cases, a memory controller may be integrated into processor 1140. The processor 1140 may be configured to execute computer-readable instructions stored in a memory (e.g., the memory 1130) to cause the device 1105 to perform various functions (e.g., functions or tasks supporting interference measurement of sensing signals).

The inter-station communications manager 1145 may manage communications with other base station 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communication network technology to provide communication between base stations 105.

The code 1135 may include instructions to implement aspects of the present disclosure, including instructions to support wireless communications. The code 1135 may be stored in a non-transitory computer-readable medium such as system memory or other type of memory. In some cases, the code 1135 may not be directly executable by the processor 1140 but may cause a computer (e.g., when compiled and executed) to perform functions described herein.

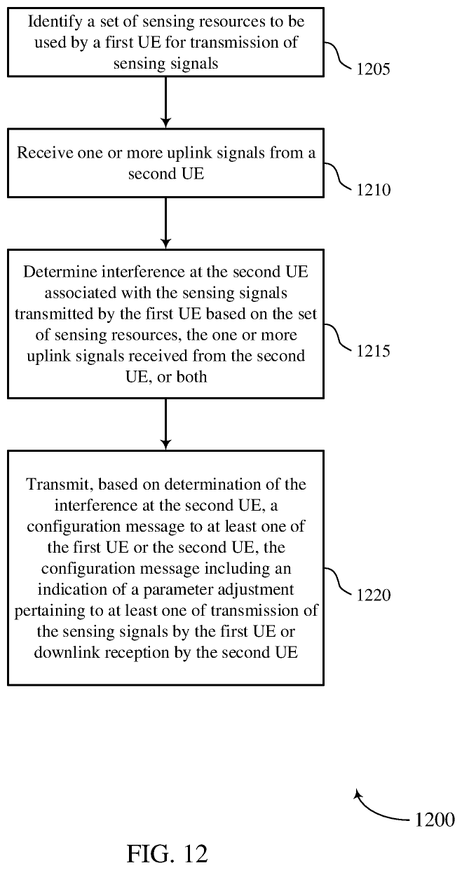

FIG. 12 shows a flowchart illustrating a method 1200 that supports interference measurement of sensing signals in accordance with aspects of the present disclosure. The operations of method 1200 may be implemented by a base station 105 or its components as described herein. For example, the operations of method 1200 may be performed by a communications manager as described with reference to FIGS. 8 through 11. In some examples, a base station may execute a set of instructions to control the functional elements of the base station to perform the functions described below. Additionally or alternatively, a base station may perform aspects of the functions described below using special-purpose hardware.

At 1205, the base station may identify a set of sensing resources to be used by a first UE for transmission of sensing signals. The operations of 1205 may be performed according to the methods described herein. In some examples, aspects of the operations of 1205 may be performed by a sensing resource manager as described with reference to FIGS. 8 through 11.

At 1210, the base station may receive one or more uplink signals from a second UE. The operations of 1210 may be performed according to the methods described herein. In some examples, aspects of the operations of 1210 may be performed by an uplink receiving manager as described with reference to FIGS. 8 through 11.

At 1215, the base station may determine interference at the second UE associated with the sensing signals transmitted by the first UE based on the set of sensing resources, the one or more uplink signals received from the second UE, or both. The operations of 1215 may be performed according to the methods described herein. In some examples, aspects of the operations of 1215 may be performed by a sensing signal interference manager as described with reference to FIGS. 8 through 11.

At 1220, the base station may transmit, based on determination of the interference at the second UE, a configuration message to at least one of the first UE or the second UE, the configuration message including an indication of a parameter adjustment pertaining to at least one of transmission of the sensing signals by the first UE or downlink reception by the second UE. The operations of 1220 may be performed according to the methods described herein. In some examples, aspects of the operations of 1220 may be performed by a configuration message transmitting manager as described with reference to FIGS. 8 through 11.

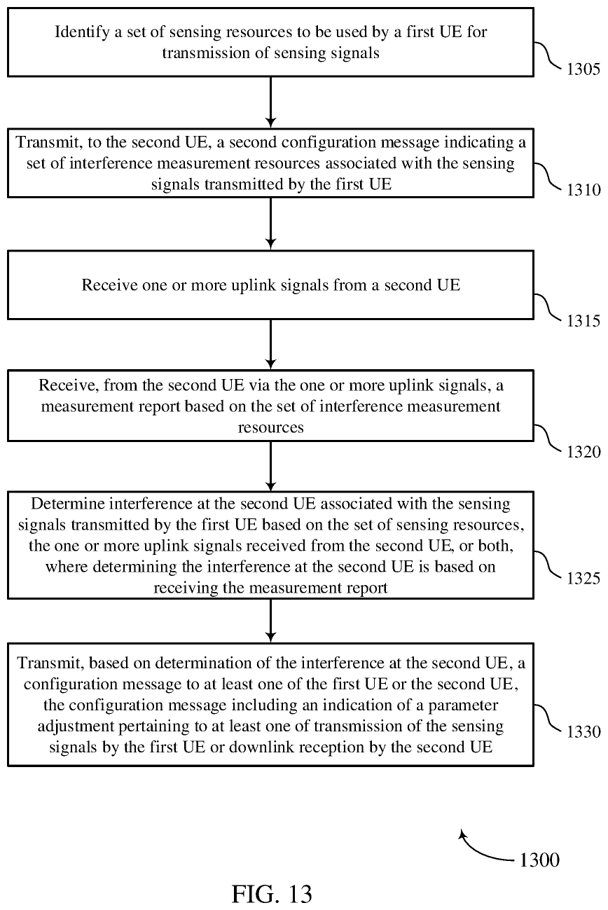

FIG. 13 shows a flowchart illustrating a method 1300 that supports interference measurement of sensing signals in accordance with aspects of the present disclosure. The operations of method 1300 may be implemented by a base station 105 or its components as described herein. For example, the operations of method 1300 may be performed by a communications manager as described with reference to FIGS. 8 through 11. In some examples, a base station may execute a set of instructions to control the functional elements of the base station to perform the functions described below. Additionally or alternatively, a base station may perform aspects of the functions described below using special-purpose hardware.

At 1305, the base station may identify a set of sensing resources to be used by a first UE for transmission of sensing signals. The operations of 1305 may be performed according to the methods described herein. In some examples, aspects of the operations of 1305 may be performed by a sensing resource manager as described with reference to FIGS. 8 through 11.

At 1310, the base station may transmit, to the second UE, a second configuration message indicating a set of interference measurement resources associated with the sensing signals transmitted by the first UE. The operations of 1310 may be performed according to the methods described herein. In some examples, aspects of the operations of 1310 may be performed by a configuration message transmitting manager as described with reference to FIGS. 8 through 11.

At 1315, the base station may receive one or more uplink signals from a second UE. The operations of 1315 may be performed according to the methods described herein. In some examples, aspects of the operations of 1315 may be performed by an uplink receiving manager as described with reference to FIGS. 8 through 11.

At 1320, the base station may receive, from the second UE via the one or more uplink signals, a measurement report based on the set of interference measurement resources. The operations of 1320 may be performed according to the methods described herein. In some examples, aspects of the operations of 1320 may be performed by an uplink signal receiving manager as described with reference to FIGS. 8 through 11.

At 1325, the base station may determine interference at the second UE associated with the sensing signals transmitted by the first UE based on the set of sensing resources, the one or more uplink signals received from the second UE, or both, where determining the interference at the second UE is based on receiving the measurement report. The operations of 1325 may be performed according to the methods described herein. In some examples, aspects of the operations of 1325 may be performed by a sensing signal interference manager as described with reference to FIGS. 8 through 11.

At 1330, the base station may transmit, based on determination of the interference at the second UE, a configuration message to at least one of the first UE or the second UE, the configuration message including an indication of a parameter adjustment pertaining to at least one of transmission of the sensing signals by the first UE or downlink reception by the second UE. The operations of 1330 may be performed according to the methods described herein. In some examples, aspects of the operations of 1330 may be performed by a configuration message transmitting manager as described with reference to FIGS. 8 through 11.

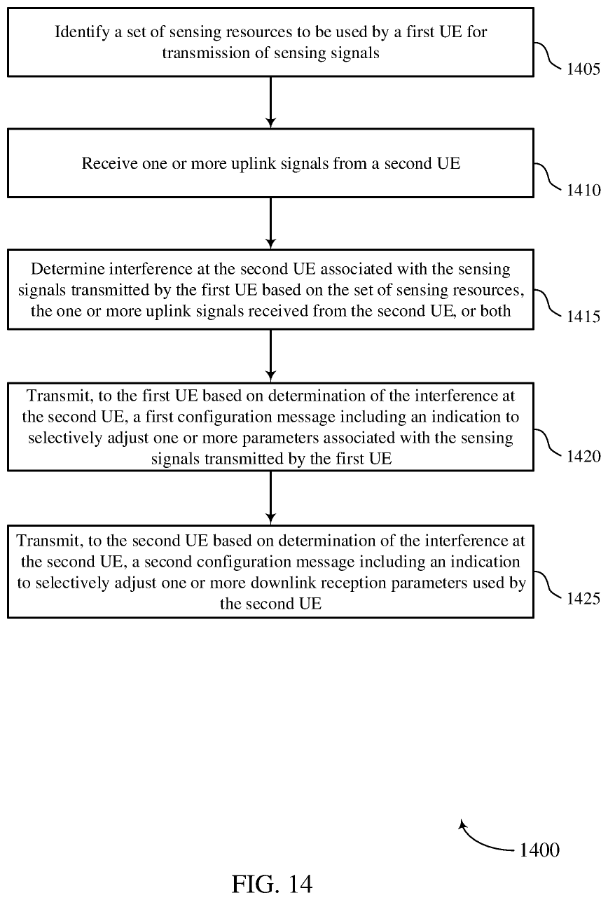

FIG. 14 shows a flowchart illustrating a method 1400 that supports interference measurement of sensing signals in accordance with aspects of the present disclosure. The operations of method 1400 may be implemented by a base station 105 or its components as described herein. For example, the operations of method 1400 may be performed by a communications manager as described with reference to FIGS. 8 through 11. In some examples, a base station may execute a set of instructions to control the functional elements of the base station to perform the functions described below. Additionally or alternatively, a base station may perform aspects of the functions described below using special-purpose hardware.

At 1405, the base station may identify a set of sensing resources to be used by a first UE for transmission of sensing signals. The operations of 1405 may be performed according to the methods described herein. In some examples, aspects of the operations of 1405 may be performed by a sensing resource manager as described with reference to FIGS. 8 through 11.

At 1410, the base station may receive one or more uplink signals from a second UE. The operations of 1410 may be performed according to the methods described herein. In some examples, aspects of the operations of 1410 may be performed by an uplink receiving manager as described with reference to FIGS. 8 through 11.

At 1415, the base station may determine interference at the second UE associated with the sensing signals transmitted by the first UE based on the set of sensing resources, the one or more uplink signals received from the second UE, or both. The operations of 1415 may be performed according to the methods described herein. In some examples, aspects of the operations of 1415 may be performed by a sensing signal interference manager as described with reference to FIGS. 8 through 11.

At 1420, the base station may transmit, to the first UE based on determination of the interference at the second UE, a first configuration message including an indication to selectively adjust one or more parameters associated with the sensing signals transmitted by the first UE. The operations of 1420 may be performed according to the methods described herein. In some examples, aspects of the operations of 1420 may be performed by a configuration message transmitting manager as described with reference to FIGS. 8 through 11.

At 1425, the base station may transmit, to the second UE based on determination of the interference at the second UE, a second configuration message including an indication to selectively adjust one or more downlink reception parameters used by the second UE. The operations of 1425 may be performed according to the methods described herein. In some examples, aspects of the operations of 1425 may be performed by a configuration message transmitting manager as described with reference to FIGS. 8 through 11.

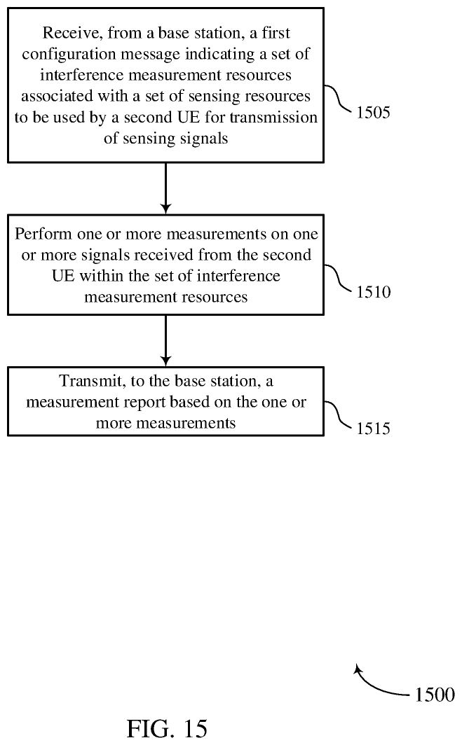

FIG. 15 shows a flowchart illustrating a method 1500 that supports interference measurement of sensing signals in accordance with aspects of the present disclosure. The operations of method 1500 may be implemented by a UE 115 or its components as described herein. For example, the operations of method 1500 may be performed by a communications manager as described with reference to FIGS. 4 through 7. In some examples, a UE may execute a set of instructions to control the functional elements of the UE to perform the functions described below. Additionally or alternatively, a UE may perform aspects of the functions described below using special-purpose hardware.

At 1505, the UE may receive, from a base station, a first configuration message indicating a set of interference measurement resources associated with a set of sensing resources to be used by a second UE for transmission of sensing signals. The operations of 1505 may be performed according to the methods described herein. In some examples, aspects of the operations of 1505 may be performed by a configuration message receiving manager as described with reference to FIGS. 4 through 7.

At 1510, the UE may perform one or more measurements on one or more signals received from the second UE within the set of interference measurement resources. The operations of 1510 may be performed according to the methods described herein. In some examples, aspects of the operations of 1510 may be performed by a signal measurement manager as described with reference to FIGS. 4 through 7.

At 1515, the UE may transmit, to the base station, a measurement report based on the one or more measurements. The operations of 1515 may be performed according to the methods described herein. In some examples, aspects of the operations of 1515 may be performed by a measurement report transmitting manager as described with reference to FIGS. 4 through 7.

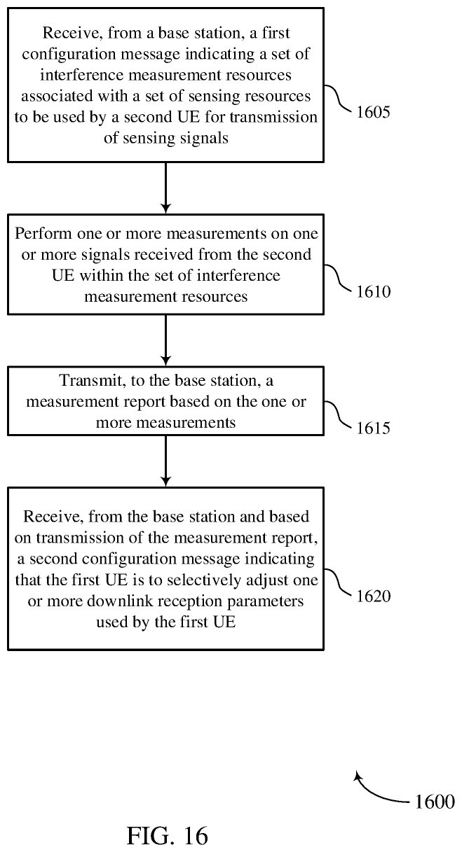

FIG. 16 shows a flowchart illustrating a method 1600 that supports interference measurement of sensing signals in accordance with aspects of the present disclosure. The operations of method 1600 may be implemented by a UE 115 or its components as described herein. For example, the operations of method 1600 may be performed by a communications manager as described with reference to FIGS. 4 through 7. In some examples, a UE may execute a set of instructions to control the functional elements of the UE to perform the functions described below. Additionally or alternatively, a UE may perform aspects of the functions described below using special-purpose hardware.

At 1605, the UE may receive, from a base station, a first configuration message indicating a set of interference measurement resources associated with a set of sensing resources to be used by a second UE for transmission of sensing signals. The operations of 1605 may be performed according to the methods described herein. In some examples, aspects of the operations of 1605 may be performed by a configuration message receiving manager as described with reference to FIGS. 4 through 7.

At 1610, the UE may perform one or more measurements on one or more signals received from the second UE within the set of interference measurement resources. The operations of 1610 may be performed according to the methods described herein. In some examples, aspects of the operations of 1610 may be performed by a signal measurement manager as described with reference to FIGS. 4 through 7.

At 1615, the UE may transmit, to the base station, a measurement report based on the one or more measurements. The operations of 1615 may be performed according to the methods described herein. In some examples, aspects of the operations of 1615 may be performed by a measurement report transmitting manager as described with reference to FIGS. 4 through 7.

At 1620, the UE may receive, from the base station and based on transmission of the measurement report, a second configuration message indicating that the first UE is to selectively adjust one or more downlink reception parameters used by the first UE. The operations of 1620 may be performed according to the methods described herein. In some examples, aspects of the operations of 1620 may be performed by a configuration message receiving manager as described with reference to FIGS. 4 through 7.

It should be noted that the methods described herein describe possible implementations, and that the operations and the steps may be rearranged or otherwise modified and that other implementations are possible. Further, aspects from two or more of the methods may be combined.

The following provides an overview of examples of the present disclosure.

Example 1: A method for wireless communication at a base station, including: identifying a set of sensing resources to be used by a first UE for transmission of sensing signals; receiving one or more uplink signals from a second UE; determining interference at the second UE associated with the sensing signals transmitted by the first UE based at least in part on the set of sensing resources, the one or more uplink signals received from the second UE, or both; and transmitting, based at least in part on determination of the interference at the second UE, a configuration message to at least one of the first UE or the second UE, the configuration message including an indication of a parameter adjustment pertaining to at least one of transmission of the sensing signals by the first UE or downlink reception by the second UE.

Example 2: The method of Example 1, further including: transmitting, to the second UE, a second configuration message indicating a set of interference measurement resources associated with the sensing signals transmitted by the first UE; and receiving, from the second UE via the one or more uplink signals, a measurement report based at least in part on the set of interference measurement resources, where determining the interference at the second UE is based at least in part on receiving the measurement report.

Example 3: The method of Example 2, further including: transmitting, to the second UE via the second configuration message, information indicative that the set of interference measurement resources include an entire reception bandwidth associated with the second UE.

Example 4: The method of any of Examples 2 or 3, further including: transmitting, to the second UE via the second configuration message, an indication that the set of interference measurement resources include a set of cross-link interference measurement resources for measuring interference associated with the sensing signals transmitted by the first UE.

Example 5: The method of Example 4, where the set of cross-link interference measurement resources for measuring interference associated with the sensing signals transmitted by the first UE have a lesser priority than a set of downlink resources used by the second UE which at least partially overlap with the set of cross-link interference measurement resources.

Example 6: The method of any of Examples 2 through 5, further including: where the set of interference measurement resources include a set of cross-link interference measurement resources for measuring a received signal strength indicator of the sensing signals transmitted by the first UE.

Example 7: The method of any of Examples 2 through 6, where the set of interference measurement resources include a set of cross-link interference measurement resources for measuring one or more parameters associated with reference signals transmitted by the first UE.

Example 8: The method of any of Examples 1 through 7, where transmitting the configuration message to at least one of the first UE or the second UE includes: transmitting, to the first UE, a first configuration message including an indication to selectively adjust one or more parameters associated with the sensing signals transmitted by the first UE; and transmitting, to the second UE, a second configuration message including an indication to selectively adjust one or more downlink reception parameters used by the second UE.

Example 9: The method of any of Examples 1 through 8, further including: transmitting, to the first UE, a configuration for the set of sensing resources to be used for transmission of the sensing signals.

Example 10: The method of any of Examples 1 through 9, where identifying the set of sensing resources includes: receiving, from the first UE, an uplink message indicating the set of sensing resources to be used for transmission of the sensing signals.

Example 11: The method of any of Examples 1 through 10, where determining the interference at the second UE includes: determining a relative position of the second UE with respect to the first UE; and determining the interference at the second UE based at least in part on the relative position.

Example 12: The method of Example 11, where determining the relative position of the second UE with respect to the first UE includes: determining a pathloss between the first UE and the second UE.

Example 13: The method of any of Examples 11 and 12, further including: including the second UE and the relative position of the second UE in a storage object that also includes other UEs and respective other relative positions in relation to the first UE.

Example 14: The method of any of Examples 1 through 13, where the set of sensing resources include a set of time resources and a set of frequency resources.

Example 15: The method of any of Examples 1 through 14, further including: identifying that a first subcarrier spacing associated with the set of sensing resources is larger than a second subcarrier spacing associated with an active bandwidth part of the second UE.

Example 16: The method of Example 15, further including: including, in the configuration message transmitted to the first UE, a sensing signal adjustment such that less than all symbols configured for the sensing signals are used for transmission of the sensing signals.

Example 17: The method of any of Examples 15 and 16, further including: including, in the configuration message transmitted to the first UE, a subcarrier spacing adjustment such that the first subcarrier spacing is updated to equal the second subcarrier spacing.

Example 18: The method of any of Examples 15 through 17, where a starting position and a number of symbols in the sensing signals are not multiples of the first subcarrier spacing divided by the second subcarrier spacing.

Example 19: A method for wireless communication at a first UE, including: receiving, from a base station, a first configuration message indicating a set of interference measurement resources associated with a set of sensing resources to be used by a second UE for transmission of sensing signals; performing one or more measurements on one or more signals received from the second UE within the set of interference measurement resources; and transmitting, to the base station, a measurement report based at least in part on the one or more measurements.

Example 20: The method of Example 19, further including: receiving, from the base station and based at least in part on transmission of the measurement report, a second configuration message indicating that the first UE is to selectively adjust one or more downlink reception parameters used by the first UE.

Example 21: The method of any of Examples 19 through 20, further including: receiving, from the base station via the first configuration message, an indication that the set of interference measurement resources comprise a set of cross-link interference measurement resources for measuring interference associated with the sensing signals transmitted by the second UE.

Example 22: The method of Example 21, where the set of cross-link interference measurement resources for measuring interference associated with the sensing signals transmitted by the second UE have a lesser priority than a set of downlink resources used by the first UE which at least partially overlap with the set of cross-link interference measurement resources.

Example 23: The method of Example 22, further including: determining that the set of cross-link interference measurement resources at least partially overlap with the set of downlink resources used by the first UE; refraining from performing measurements using the set of cross-link interference measurement resources based at least in part on determining that the cross-link interference measurement resources at least partially overlap with the set of downlink resources; and receiving one or more downlink messages using the set of downlink resources based at least in part on determining that the cross-link interference measurement resources at least partially overlap with the set of downlink resources.

Example 24: The method of any of Examples 19 through 23, further including: receiving, from the base station via the first configuration message, an indication that the set of interference measurement resources include a set of cross-link interference measurement resources for measuring a received signal strength indicator of the sensing signals transmitted by the second UE; and receiving the sensing signals transmitted by the second UE, where the one or more measurements are performed on the sensing signal based on the indication that the set of interference measurement resources include a set of cross-link interference measurement resources for measuring a received signal strength indicator of the sensing signals.

Example 25: The method of any of Examples 19 through 24, further including: receiving, from the base station via the first configuration message, an indication that the set of interference measurement resources include a set of cross-link interference measurement resources for measuring a one or more parameters associated with reference signals transmitted by the first UE; and receiving reference signals transmitted by the second UE, where the one or more measurements are performed on the reference signals based on the indication that the set of interference measurement resources include a set of cross-link interference measurement resources for measuring a one or more parameters associated with the reference signals.

Example 26: The method of any of Examples 19 through 25, further including: receiving, from the base station, information indicative that the set of interference measurement resources include an entire reception bandwidth associated with the first UE.

Example 27: The method of any of Examples 19 through 26, where the set of interference measurement resources include a set of time resources and a set of frequency resources.

Example 28: The method of any of Examples 19 through 27, further including: identifying that a first subcarrier spacing associated with the set of sensing resources is larger than a second subcarrier spacing associated with an active bandwidth part of the second UE.

Example 29: The method of Example 28, further including: identifying that less than all symbols configured for the sensing signals are used for transmission of the sensing signals.

Example 30: The method of any of Examples 28 through 29, further including: identifying that a starting position and a number of symbols in the sensing signals are not multiples of the first subcarrier spacing divided by the second subcarrier spacing.

Example 31: An apparatus for wireless communication at a base station, including: a processor, memory coupled with the processor; and instructions stored in the memory and executable by the processor to cause the apparatus to: identify a set of sensing resources to be used by a first UE for transmission of sensing signals; receive one or more uplink signals from a second UE; determine interference at the second UE associated with the sensing signals transmitted by the first UE based at least in part on the set of sensing resources, the one or more uplink signals received from the second UE, or both; and transmit, based at least in part on determination of the interference at the second UE, a configuration message to at least one of the first UE or the second UE, the configuration message including an indication of a parameter adjustment pertaining to at least one of transmission of the sensing signals by the first UE or downlink reception by the second UE.

Example 32: The apparatus of Example 31, where the instructions are further executable by the processor to cause the apparatus to: transmit, to the second UE, a second configuration message indicating a set of interference measurement resources associated with the sensing signals transmitted by the first UE; and receive, from the second UE via the one or more uplink signals, a measurement report based at least in part on the set of interference measurement resources, where determining the interference at the second UE is based at least in part on receiving the measurement report.

Example 33: The apparatus of Example 32, where the instructions are further executable by the processor to cause the apparatus to: transmit, to the second UE via the second configuration message, information indicative that the set of interference measurement resources include an entire reception bandwidth associated with the second UE.

Example 34: The apparatus of Examples 32 through 33, where the instructions are further executable by the processor to cause the apparatus to: transmit, to the second UE via the second configuration message, an indication that the set of interference measurement resources include a set of cross-link interference measurement resources for measuring interference associated with the sensing signals transmitted by the first UE.

Example 35: The apparatus of Example 34, where the set of cross-link interference measurement resources for measuring interference associated with the sensing signals transmitted by the first UE have a lesser priority than a set of downlink resources used by the second UE which at least partially overlap with the set of cross-link interference measurement resources.

Example 36: The apparatus of any of Examples 32 through 35, where the set of interference measurement resources include a set of cross-link interference measurement resources for measuring a received signal strength indicator of the sensing signals transmitted by the first UE.

Example 37: The apparatus of any of Examples 32 through 36, where the set of interference measurement resources include a set of cross-link interference measurement resources for measuring one or more parameters associated with reference signals transmitted by the first UE.

Example 38: The apparatus of any of Examples 31 through 37, where the instructions to transmit the configuration message to at least one of the first UE or the second UE are executable by the processor to cause the apparatus to: transmit, to the first UE, a first configuration message including an indication to selectively adjust one or more parameters associated with the sensing signals transmitted by the first UE; and transmit, to the second UE, a second configuration message including an indication to selectively adjust one or more downlink reception parameters used by the second UE.

Example 39: The apparatus of any of Examples 31 through 38, where the instructions are further executable by the processor to cause the apparatus to: transmit, to the first UE, a configuration for the set of sensing resources to be used for transmission of the sensing signals.

Example 40: The apparatus of any of Examples 31 through 39, where the instructions to identify the set of sensing resources are executable by the processor to cause the apparatus to: receive, from the first UE, an uplink message indicating the set of sensing resources to be used for transmission of the sensing signals.

Example 41: The apparatus of any of Examples 31 through 40, where the instructions to determine the interference at the second UE are executable by the processor to cause the apparatus to: determine a relative position of the second UE with respect to the first UE; and determine the interference at the second UE based at least in part on the relative position.

Example 42: The apparatus of Example 41, where the instructions to determine the relative position of the second UE with respect to the first UE are executable by the processor to cause the apparatus to: determine a pathloss between the first UE and the second UE.

Example 43: The apparatus of any of Examples 41 through 42, where the instructions are further executable by the processor to cause the apparatus to: include the second UE and the relative position of the second UE in a storage object that also includes other UEs and respective other relative positions in relation to the first UE.

Example 44: The apparatus of any of Examples 31 through 43, where the set of sensing resources comprise a set of time resources and a set of frequency resources.

Example 45: The apparatus of any of Examples 31 through 44, where the instructions are further executable by the processor to cause the apparatus to: identify that a first subcarrier spacing associated with the set of sensing resources is larger than a second subcarrier spacing associated with an active bandwidth part of the second UE.

Example 46: The apparatus of Example 45, where the instructions are further executable by the processor to cause the apparatus to: include, in the configuration message transmitted to the first UE, a sensing signal adjustment such that less than all symbols configured for the sensing signals are used for transmission of the sensing signals.

Example 47: The apparatus of any of Examples 45 through 46, where the instructions are further executable by the processor to cause the apparatus to: include, in the configuration message transmitted to the first UE, a subcarrier spacing adjustment such that the first subcarrier spacing is updated to equal the second subcarrier spacing.

Example 48: The apparatus of any of Examples 45 through 47, where a starting position and a number of symbols in the sensing signals are not multiples of the first subcarrier spacing divided by the second subcarrier spacing.

Example 49: An apparatus for wireless communication at a first UE, including: a processor, memory coupled with the processor; and instructions stored in the memory and executable by the processor to cause the apparatus to: receive, from a base station, a first configuration message indicating a set of interference measurement resources associated with a set of sensing resources to be used by a second UE for transmission of sensing signals; perform one or more measurements on one or more signals received from the second UE within the set of interference measurement resources; and transmit, to the base station, a measurement report based at least in part on the one or more measurements.

Example 50: The apparatus of Example 49, where the instructions are further executable by the processor to cause the apparatus to: receive, from the base station and based at least in part on transmission of the measurement report, a second configuration message indicating that the first UE is to selectively adjust one or more downlink reception parameters used by the first UE.

Example 51: The apparatus of any of Examples 49 through 50, where the instructions are further executable by the processor to cause the apparatus to: receive, from the base station via the first configuration message, an indication that the set of interference measurement resources include a set of cross-link interference measurement resources for measuring interference associated with the sensing signals transmitted by the second UE.

Example 52: The apparatus of Example 51, where the set of cross-link interference measurement resources for measuring interference associated with the sensing signals transmitted by the second UE have a lesser priority than a set of downlink resources used by the first UE which at least partially overlap with the set of cross-link interference measurement resources.

Example 53: The apparatus of Example 52, where the instructions are further executable by the processor to cause the apparatus to: determine that the set of cross-link interference measurement resources at least partially overlap with the set of downlink resources used by the first UE; refrain from performing measurements using the set of cross-link interference measurement resources based at least in part on determining that the cross-link interference measurement resources at least partially overlap with the set of downlink resources; and receive one or more downlink messages using the set of downlink resources based at least in part on determining that the cross-link interference measurement resources at least partially overlap with the set of downlink resources.

Example 54: The apparatus of any of Examples 49 through 53, where the instructions are further executable by the processor to cause the apparatus to: receive, from the base station via the first configuration message, an indication that the set of interference measurement resources include a set of cross-link interference measurement resources for measuring a received signal strength indicator of the sensing signals transmitted by the second UE; and receive the sensing signals transmitted by the second UE, where the one or more measurements are performed on the sensing signal based on the indication that the set of interference measurement resources include a set of cross-link interference measurement resources for measuring a received signal strength indicator of the sensing signals.

Example 55: The apparatus of any of Examples 49 through 54, where the instructions are further executable by the processor to cause the apparatus to: receive, from the base station via the first configuration message, an indication that the set of interference measurement resources include a set of cross-link interference measurement resources for measuring a one or more parameters associated with reference signals transmitted by the first UE; and receive reference signals transmitted by the second UE, where the one or more measurements are performed on the reference signals based on the indication that the set of interference measurement resources include a set of cross-link interference measurement resources for measuring a one or more parameters associated with the reference signals.

Example 56: The apparatus of any of Examples 49 through 55, where the instructions are further executable by the processor to cause the apparatus to: receive, from the base station, information indicative that the set of interference measurement resources include an entire reception bandwidth associated with the first UE.

Example 57: The apparatus of any of Examples 49 through 56, where the set of interference measurement resources include a set of time resources and a set of frequency resources.

Example 58: The apparatus of any of Examples 49 through 57, where the instructions are further executable by the processor to cause the apparatus to: identify that a first subcarrier spacing associated with the set of sensing resources is larger than a second subcarrier spacing associated with an active bandwidth part of the second UE.

Example 59: The apparatus of Example 58, where the instructions are further executable by the processor to cause the apparatus to: identify that less than all symbols configured for the sensing signals are used for transmission of the sensing signals.

Example 60: The apparatus of any of Examples 58 through 59, where the instructions are further executable by the processor to cause the apparatus to: identify that a starting position and a number of symbols in the sensing signals are not multiples of the first subcarrier spacing divided by the second subcarrier spacing.

Example 61: An apparatus for wireless communication at a base station, including: means for identifying a set of sensing resources to be used by a first UE for transmission of sensing signals; means for receiving one or more uplink signals from a second UE; means for determining interference at the second UE associated with the sensing signals transmitted by the first UE based at least in part on the set of sensing resources, the one or more uplink signals received from the second UE, or both; and means for transmitting, based at least in part on determination of the interference at the second UE, a configuration message to at least one of the first UE or the second UE, the configuration message including an indication of a parameter adjustment pertaining to at least one of transmission of the sensing signals by the first UE or downlink reception by the second UE.

Example 62: An apparatus for wireless communication at a first UE, including: means for receiving, from a base station, a first configuration message indicating a set of interference measurement resources associated with a set of sensing resources to be used by a second UE for transmission of sensing signals; means for performing one or more measurements on one or more signals received from the second UE within the set of interference measurement resources; and means for transmitting, to the base station, a measurement report based at least in part on the one or more measurements.

Example 63: A non-transitory computer-readable medium storing code for wireless communication at a base station, the code including instructions executable by a processor to: identify a set of sensing resources to be used by a first UE for transmission of sensing signals; receive one or more uplink signals from a second UE; determine interference at the second UE associated with the sensing signals transmitted by the first UE based at least in part on the set of sensing resources, the one or more uplink signals received from the second UE, or both; and transmit, based at least in part on determination of the interference at the second UE, a configuration message to at least one of the first UE or the second UE, the configuration message including an indication of a parameter adjustment pertaining to at least one of transmission of the sensing signals by the first UE or downlink reception by the second UE.

Example 64: A non-transitory computer-readable medium storing code for wireless communication at a first UE, the code including instructions executable by a processor to: receive, from a base station, a first configuration message indicating a set of interference measurement resources associated with a set of sensing resources to be used by a second UE for transmission of sensing signals; perform one or more measurements on one or more signals received from the second UE within the set of interference measurement resources; and transmit, to the base station, a measurement report based at least in part on the one or more measurements.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communication at a network entity, comprising:
identifying a set of sensing resources to be used by a first user equipment (UE) for transmission of sensing signals;
receiving one or more uplink signals from a second UE;
determining interference at the second UE associated with the sensing signals transmitted by the first UE based at least in part on the set of sensing resources, the one or more uplink signals received from the second UE, or both; and
transmitting, based at least in part on determination of the interference at the second UE, a configuration message to at least one of the first UE or the second UE, the configuration message including an indication of a parameter adjustment pertaining to at least one of transmission of the sensing signals by the first UE or downlink reception by the second UE.

2. The method of claim 1, further comprising:
transmitting, to the second UE, a second configuration message indicating a set of interference measurement resources associated with the sensing signals transmitted by the first UE; and
receiving, from the second UE via the one or more uplink signals, a measurement report based at least in part on the set of interference measurement resources, wherein determining the interference at the second UE is based at least in part on receiving the measurement report.

3. The method of claim 2, further comprising:
transmitting, to the second UE via the second configuration message, information indicative that the set of interference measurement resources comprise an entire reception bandwidth associated with the second UE.

4. The method of claim 2, further comprising:
transmitting, to the second UE via the second configuration message, an indication that the set of interference measurement resources comprise a set of cross-link interference measurement resources for measuring interference associated with the sensing signals transmitted by the first UE.

5. The method of claim 4, wherein the set of cross-link interference measurement resources for measuring interference associated with the sensing signals transmitted by the first UE have a lesser priority than a set of downlink resources used by the second UE which at least partially overlap with the set of cross-link interference measurement resources.

6. The method of claim 2, wherein the set of interference measurement resources comprise a set of cross-link interference measurement resources for measuring a received signal strength indicator of the sensing signals transmitted by the first UE.

7. The method of claim 2, wherein the set of interference measurement resources comprise a set of cross-link interference measurement resources for measuring one or more parameters associated with reference signals transmitted by the first UE.

8-9. (canceled)

10. The method of claim 1, wherein identifying the set of sensing resources comprises:
receiving, from the first UE, an uplink message indicating the set of sensing resources to be used for transmission of the sensing signals.

11. The method of claim 1, wherein determining the interference at the second UE comprises:
determining a relative position of the second UE with respect to the first UE; and
determining the interference at the second UE based at least in part on the relative position.

12. The method of claim 11, wherein determining the relative position of the second UE with respect to the first UE comprises:
determining a pathloss between the first UE and the second UE.

13-14. (canceled)

15. The method of claim 1, further comprising:
identifying that a first subcarrier spacing associated with the set of sensing resources is larger than a second subcarrier spacing associated with an active bandwidth part of the second UE.

16-18. (canceled)

19. A method for wireless communication at a first user equipment (UE), comprising:
receiving, from a network entity, a first configuration message indicating a set of interference measurement resources associated with a set of sensing resources to be used by a second UE for transmission of sensing signals;
performing one or more measurements on one or more signals received from the second UE within the set of interference measurement resources; and
transmitting, to the network entity, a measurement report based at least in part on the one or more measurements.

20. The method of claim 19, further comprising:
receiving, from the network entity and based at least in part on transmission of the measurement report, a second configuration message indicating that the first UE is to selectively adjust one or more downlink reception parameters used by the first UE.

21. The method of claim 19, further comprising:
receiving, from the network entity via the first configuration message, an indication that the set of interference measurement resources comprise a set of cross-link interference measurement resources for measuring interference associated with the sensing signals transmitted by the second UE.

22. The method of claim 21, wherein the set of cross-link interference measurement resources for measuring interference associated with the sensing signals transmitted by the second UE have a lesser priority than a set of downlink resources used by the first UE which at least partially overlap with the set of cross-link interference measurement resources.

23. The method of claim 22, further comprising:
determining that the set of cross-link interference measurement resources at least partially overlap with the set of downlink resources used by the first UE;
refraining from performing measurements using the set of cross-link interference measurement resources based at least in part on determining that the cross-link interference measurement resources at least partially overlap with the set of downlink resources; and
receiving one or more downlink messages using the set of downlink resources based at least in part on determining that the cross-link interference measurement resources at least partially overlap with the set of downlink resources.

24-27. (canceled)

28. The method of claim 19, further comprising:
identifying that a first subcarrier spacing associated with the set of sensing resources is larger than a second subcarrier spacing associated with an active bandwidth part of the second UE.

29. The method of claim 28, further comprising:
identifying that less than all symbols configured for the sensing signals are used for transmission of the sensing signals.

30. (canceled)

31. An apparatus for wireless communication at a network entity, comprising:
a processor,
memory coupled with the processor; and
instructions stored in the memory and executable by the processor to cause the apparatus to:
identify a set of sensing resources to be used by a first user equipment (UE) for transmission of sensing signals;
receive one or more uplink signals from a second UE;
determine interference at the second UE associated with the sensing signals transmitted by the first UE based at least in part on the set of sensing resources, the one or more uplink signals received from the second UE, or both; and
transmit, based at least in part on determination of the interference at the second UE, a configuration message to at least one of the first UE or the second UE, the configuration message including an indication of a parameter adjustment pertaining to at least one of transmission of the sensing signals by the first UE or downlink reception by the second UE.

32. The apparatus of claim 31, wherein the instructions are further executable by the processor to cause the apparatus to:
transmit, to the second UE, a second configuration message indicating a set of interference measurement resources associated with the sensing signals transmitted by the first UE; and
receive, from the second UE via the one or more uplink signals, a measurement report based at least in part on the set of interference measurement resources, wherein determining the interference at the second UE is based at least in part on receiving the measurement report.

33. (canceled)

34. The apparatus of claim 32, wherein the instructions are further executable by the processor to cause the apparatus to:
transmit, to the second UE via the second configuration message, an indication that the set of interference measurement resources comprise a set of cross-link interference measurement resources for measuring interference associated with the sensing signals transmitted by the first UE.

35. The apparatus of claim 34, wherein the set of cross-link interference measurement resources for measuring interference associated with the sensing signals transmitted by the first UE have a lesser priority than a set of downlink resources used by the second UE which at least partially overlap with the set of cross-link interference measurement resources.

36-37. (canceled)

38. The apparatus of claim 31, wherein the instructions to transmit the configuration message to at least one of the first UE or the second UE are executable by the processor to cause the apparatus to:
transmit, to the first UE, a first configuration message comprising an indication to selectively adjust one or more parameters associated with the sensing signals transmitted by the first UE; and
transmit, to the second UE, a second configuration message comprising an indication to selectively adjust one or more downlink reception parameters used by the second UE.

39-40. (canceled)

41. The apparatus of claim 31, wherein the instructions to determine the interference at the second UE are executable by the processor to cause the apparatus to:
determine a relative position of the second UE with respect to the first UE; and
determine the interference at the second UE based at least in part on the relative position.

42-44. (canceled)

45. The apparatus of claim 31, wherein the instructions are further executable by the processor to cause the apparatus to:
identify that a first subcarrier spacing associated with the set of sensing resources is larger than a second subcarrier spacing associated with an active bandwidth part of the second UE.

46. The apparatus of claim 45, wherein the instructions are further executable by the processor to cause the apparatus to:
include, in the configuration message transmitted to the first UE, a sensing signal adjustment such that less than all symbols configured for the sensing signals are used for transmission of the sensing signals.

47-48. (canceled)

49. An apparatus for wireless communication at a first user equipment (UE), comprising:
a processor,
memory coupled with the processor; and
instructions stored in the memory and executable by the processor to cause the apparatus to:
receive, from a network entity, a first configuration message indicating a set of interference measurement resources associated with a set of sensing resources to be used by a second UE for transmission of sensing signals;
perform one or more measurements on one or more signals received from the second UE within the set of interference measurement resources; and
transmit, to the network entity, a measurement report based at least in part on the one or more measurements.

50. The apparatus of claim 49, wherein the instructions are further executable by the processor to cause the apparatus to:
receive, from the network entity and based at least in part on transmission of the measurement report, a second configuration message indicating that the first UE is to selectively adjust one or more downlink reception parameters used by the first UE.

51. The apparatus of claim 49, wherein the instructions are further executable by the processor to cause the apparatus to:
receive, from the network entity via the first configuration message, an indication that the set of interference measurement resources comprise a set of cross-link interference measurement resources for measuring interference associated with the sensing signals transmitted by the second UE.

52. The apparatus of claim 51, wherein the set of cross-link interference measurement resources for measuring interference associated with the sensing signals transmitted by the second UE have a lesser priority than a set of downlink resources used by the first UE which at least partially overlap with the set of cross-link interference measurement resources.

53. The apparatus of claim 52, wherein the instructions are further executable by the processor to cause the apparatus to:
determine that the set of cross-link interference measurement resources at least partially overlap with the set of downlink resources used by the first UE;
refrain from performing measurements using the set of cross-link interference measurement resources based at least in part on determining that the cross-link interference measurement resources at least partially overlap with the set of downlink resources; and
receive one or more downlink messages using the set of downlink resources based at least in part on determining that the cross-link interference measurement resources at least partially overlap with the set of downlink resources.

54-55. (canceled)

56. The apparatus of claim 49, wherein the instructions are further executable by the processor to cause the apparatus to:
receive, from the network entity, information indicative that the set of interference measurement resources comprise an entire reception bandwidth associated with the first UE.

57. (canceled)

58. The apparatus of claim 49, wherein the instructions are further executable by the processor to cause the apparatus to:
identify that a first subcarrier spacing associated with the set of sensing resources is larger than a second subcarrier spacing associated with an active bandwidth part of the second UE.

59-60. (canceled)

61. An apparatus for wireless communication at a network entity, comprising:
means for identifying a set of sensing resources to be used by a first user equipment (UE) for transmission of sensing signals;
means for receiving one or more uplink signals from a second UE;
means for determining interference at the second UE associated with the sensing signals transmitted by the first UE based at least in part on the set of sensing resources, the one or more uplink signals received from the second UE, or both; and
means for transmitting, based at least in part on determination of the interference at the second UE, a configuration message to at least one of the first UE or the second UE, the configuration message including an indication of a parameter adjustment pertaining to at least one of transmission of the sensing signals by the first UE or downlink reception by the second UE.

62. An apparatus for wireless communication at a first user equipment (UE), comprising:
means for receiving, from a network entity, a first configuration message indicating a set of interference measurement resources associated with a set of sensing resources to be used by a second UE for transmission of sensing signals;
means for performing one or more measurements on one or more signals received from the second UE within the set of interference measurement resources; and
means for transmitting, to the network entity, a measurement report based at least in part on the one or more measurements.

63. A non-transitory computer-readable medium storing code for wireless communication at a network entity, the code comprising instructions executable by a processor to:
identify a set of sensing resources to be used by a first user equipment (UE) for transmission of sensing signals;
receive one or more uplink signals from a second UE;
determine interference at the second UE associated with the sensing signals transmitted by the first UE based at least in part on the set of sensing resources, the one or more uplink signals received from the second UE, or both; and
transmit, based at least in part on determination of the interference at the second UE, a configuration message to at least one of the first UE or the second UE, the configuration message including an indication of a parameter adjustment pertaining to at least one of transmission of the sensing signals by the first UE or downlink reception by the second UE.

64. A non-transitory computer-readable medium storing code for wireless communication at a first user equipment (UE), the code comprising instructions executable by a processor to:
receive, from a network entity, a first configuration message indicating a set of interference measurement resources associated with a set of sensing resources to be used by a second UE for transmission of sensing signals;
perform one or more measurements on one or more signals received from the second UE within the set of interference measurement resources; and
transmit, to the network entity, a measurement report based at least in part on the one or more measurements.
